(19) United States
(12) Patent Application Publication
(10) Pub. No.: US 2026/0146110 A1
(43) Pub. Date: May 28, 2026

(54) FLUORINATED POLYAROMATICS WITH LINEAR, BRANCHED OR CROSSLINKED STRUCTURE FOR ANION EXCHANGE MEMBRANES AND IONOMERS

(71) Applicant: ECOLE POLYTECHNIQUE FEDERALE DE LAUSANNE (EPFL), Lausanne (CH)

(72) Inventors: Xile HU, Lausanne (CH); Nanjun CHEN, Lausanne (CH); Xingyu WU, Lausanne (CH)

(73) Assignee: ECOLE POLYTECHNIQUE FEDERALE DE LAUSANNE (EPFL), Lausanne (CH)

(21) Appl. No.: 19/127,117

(22) PCT Filed: Nov. 6, 2023
(86) PCT No.: PCT/EP2023/080876

§ 371 Date: May 4, 2025

(30) Foreign Application Priority Data
Nov. 4, 2022 (EP) 22205637.6

(51) Int. Cl. C08F 26/06; C08F 26/02; C08J 3/24

(52) U.S. Cl. CPC C08F 26/06; C08F 26/02; C08J 3/24

(57) ABSTRACT

The present specification relates to a fluorinated polyaromatic polymer comprising
at least one fluorinated unit FU of formula I

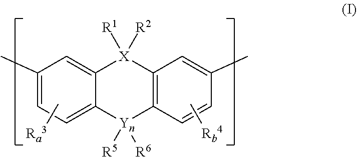

and
at least one cationic unit CU of formula B or C

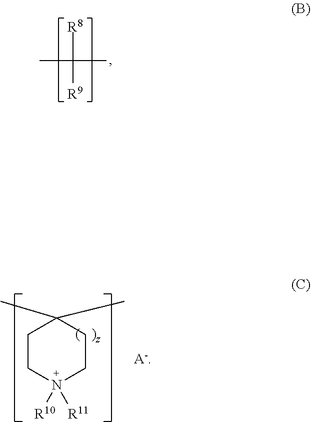

The present invention relates to fluorinated polyaromatics polymers for use as anion exchange membranes and ionomers.

### BACKGROUND

Anion exchange membranes (AEMs) and ionomers are critical materials for many applications, such as anion exchange membrane fuel cells (AEMFCs), anion exchange membrane water electrolyzers (AEMWEs), CO2 electrolyzers, acid/base recycle and so on. However, the development of AEMs and ionomers with desirable alkaline and oxidation stabilities, mechanical properties and dimensional stabilities are very challenging.

Yan et al. 2017 (WO 2017 172824 A1)¹ and Bae et al. 2015 (U.S. Ser. No. 11/236,196 B2)² claim polyaromatic polymers with trifluoromethyl ketone for use in anion exchange membrane and ionomers. However, the fluorine content in the claimed polymers is below 5% which results in less improved hydrophobicity.

Wu et al. 20223 and Chen et al. 20194 reported branched polyaromatics and crosslinked polyaromatics, respectively, for use as anion exchange membrane, however, the reported polyaromatic polymers do not contain fluorine elements and thus do show less hydrophobicity.

Based on the above-mentioned state of the art, the objective of the present invention is to provide means and methods to fluorinated polyaromatics with linear, branched or crosslinked structure to be used in anion exchange membranes and ionomers with improved hydrophobicity which leads to improved mechanical properties. This objective is attained by the subject-matter of the independent claims of the present specification, with further advantageous embodiments described in the dependent claims, examples, figures and general description of this specification.

### SUMMARY OF THE INVENTION

A first aspect of the invention relates to a fluorinated polyaromatic polymer comprising
at least one fluorinated unit FU of formula (I)

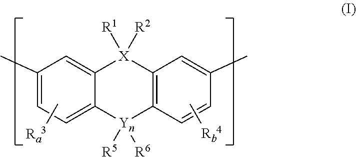

wherein
X is C or N,
Y is C,
R¹, R², R⁵ and R⁶ are independently selected from

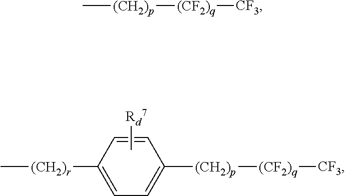

H,
—C₁-C₁₀ alkyl, wherein the —C₁-C₁₀ alkyl is substituted or unsubstituted, particularly —C₁-C₆ alkyl,
—C₂-C₁₀ alkenyl, wherein the —C₂-C₁₀ alkenyl is substituted or unsubstituted, particularly —C₂-C₆ alkenyl,
—C₂-C₁₀ alkynyl, wherein the —C₂-C₁₀ alkynyl is substituted or unsubstituted, particularly C₂-C₆ alkynyl,
wherein at least one of R¹, R², R⁵ and R⁶ is

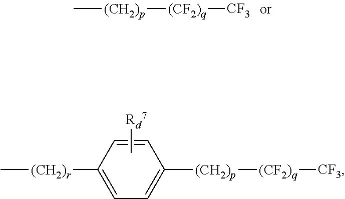

Rₐ³, R_{b}⁴ and R_{d}⁷ are independently selected from
   —C₁-C₁₀ alkyl, wherein the —C₁-C₁₀ alkyl is substituted or unsubstituted, particularly —C₁-C₆ alkyl,
   —C₂-C₁₀ alkenyl, wherein the —C₂-C₁₀ alkenyl is substituted or unsubstituted, particularly —C₂-C₆ alkenyl,
   —C₂-C₁₀ alkynyl, wherein the —C₂-C₁₀ alkynyl is substituted or unsubstituted, particularly C₂-C₆ alkynyl,
a and b are independently 0, 1, 2, or 3, particularly 0 or 1, more particularly 0,
d is 0, 1, 2, 3 or 4, particularly 0 or 1, more particularly 0,
n is 0 or 1,
r is, 1, 2, 3, 4, 5 or 6, particularly, 1, 2, or 3, more particularly 1 or 2,
p is independently between 1 and 20, particularly 1 and 15, more particularly 1 and 9, and
q is independently between 0 and 20, particularly 0 and 15, more particularly 0 and 9,
   and
at least one cationic unit CU of formula (B) or (C)

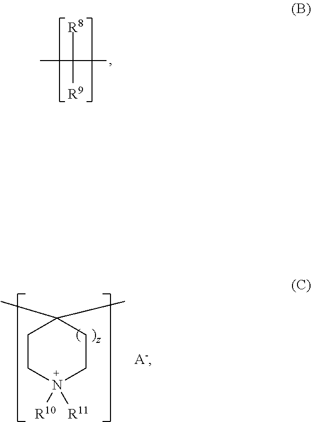

wherein
R⁸ is a partially or fully fluorinated C₁-C₆ alkyl, particularly CF₃,
R⁹ is selected from
   —C₁-C₁₀ alkyl, wherein the —C₁-C₁₀ alkyl is substituted or unsubstituted, particularly —C₁-C₆ alkyl,
   —C₂-C₁₀ alkenyl, wherein the —C₂-C₁₀ alkenyl is substituted or unsubstituted, particularly —C₂-C₆ alkenyl,
   —C₂-C₁₀ alkynyl, wherein the —C₂-C₁₀ alkynyl is substituted or unsubstituted, particularly C₂-C₆ alkynyl,
   —(CH₂)ₛ—N(R¹²)₂,
   —(CH₂)ₛ—NHR¹²
   —(CH₂)ₛ—N⁺(R¹²)_{3′}
   wherein R¹² is independently selected from
      —C₁-C₁₀ alkyl, wherein the —C₁-C₁₀ alkyl is substituted or unsubstituted, particularly —C₁-C₆ alkyl,
      —C₂-C₁₀ alkenyl, wherein the —C₂-C₁₀ alkenyl substituted or unsubstituted, particularly —C₂-C₆ alkenyl,
      —C₂-C₁₀ alkynyl, wherein the —C₂-C₁₀ alkynyl is substituted or unsubstituted, particularly C₂-C₆ alkynyl,
      s is between 0 and 20
      -Ph-R_{f}¹³
R¹⁰ and R¹¹ are independently selected from
   H
   —C₁-C₁₀ alkyl, wherein the —C₁-C₁₀ alkyl is substituted or unsubstituted, particularly —C₁-C₆ alkyl,
   —C₂-C₁₀ alkenyl, wherein the —C₂-C₁₀ alkenyl is substituted or unsubstituted, particularly —C₂-C₆ alkenyl,
   —C₂-C₁₀ alkynyl, wherein the —C₂-C₁₀ alkynyl is substituted or unsubstituted, particularly C₂-C₆ alkynyl,
or R¹⁰ and R¹¹ are connected to each other to form a cycloalkyl comprising
4 to 10 C atoms,
z is 0 or 1,
A⁻ is an anion.

A second aspect of the invention relates to a method for preparing a fluorinated polyaromatic polymer comprising one or more linear units LU comprising reacting at least one fluorinated unit precursor FUP and at least one cationic unit precursor CUP and optionally at least one bifunctional aromatic moiety precursor BAP.

A third aspect of the invention relates to a method for preparing a fluorinated polyaromatic polymer comprising a branched unit BU comprising three or more linear units LU connected through a branching unit reagent BUR, comprising reacting at least one fluorinated unit precursor FUP and optionally at least one cationic unit precursor CUP and optionally at least one bifunctional aromatic moiety precursor BAP and a branching unit precursor BUP.

A fourth aspect of the invention relates to a method for preparing a fluorinated polyaromatic polymer comprising a crosslinking unit CU comprising two or more linear units LU connected through one or more crosslinkers CL comprising
reacting at least one fluorinated unit precursor FUP and at least one cationic unit precursor CUP and optionally at least one bifunctional aromatic moiety precursor BAP yielding an intermediate polymer, and
reacting the intermediate polymer with at least one crosslinking unit precursor CLU.

### Terms and Definitions

For purposes of interpreting this specification, the following definitions will apply and whenever appropriate, terms used in the singular will also include the plural and vice versa. In the event that any definition set forth below conflicts with any document incorporated herein by reference, the definition set forth shall control.

The terms “comprising”, “having”, “containing”, and “including”, and other similar forms, and grammatical equivalents thereof, as used herein, are intended to be equivalent in meaning and to be open-ended in that an item or items following any one of these words is not meant to be an exhaustive listing of such item or items, or meant to be limited to only the listed item or items. For example, an article “comprising” components A, B, and C can consist of (i.e., contain only) components A, B, and C, or can contain not only components A, B, and C but also one or more other components. As such, it is intended and understood that “comprises” and similar forms thereof, and grammatical equivalents thereof, include disclosure of embodiments of “consisting essentially of” or “consisting of.”

Where a range of values is provided, it is understood that each intervening value, to the tenth of the unit of the lower limit, unless the context clearly dictates otherwise, between the upper and lower limit of that range and any other stated or intervening value in that stated range, is encompassed within the disclosure, subject to any specifically excluded limit in the stated range. Where the stated range includes one or both of the limits, ranges excluding either or both of those included limits are also included in the disclosure.

Reference to “about” a value or parameter herein includes (and describes) variations that are directed to that value or parameter per se. For example, description referring to “about X” includes description of “X.”

As used herein, including in the appended claims, the singular forms “a”, “or” and “the” include plural referents unless the context clearly dictates otherwise.

“And/or” where used herein is to be taken as specific recitation of each of the two specified features or components with or without the other. Thus, the term “and/or” as used in a phrase such as “A and/or B” herein is intended to include “A and B,” “A or B,” “A” (alone), and “B” (alone). Likewise, the term “and/or” as used in a phrase such as “A, B, and/or C” is intended to encompass each of the following aspects: A, B, and C; A, B, or C; A or C; A or B; B or C; A and C; A and B; B and C; A (alone); B (alone); and C (alone).

Unless defined otherwise, all technical and scientific terms used herein have the same meaning as commonly understood by one of ordinary skill in the art (e.g., in cell culture, molecular genetics, nucleic acid chemistry, hybridization techniques and biochemistry, organic synthesis). Standard techniques are used for chemical methods.

The term fluorinated polyaromatic polymer in the context of the present specification relates to a polymer that comprises at least one fluorinated unit FU and at least one cationic unit CU and optionally at least one bifunctional aromatic moiety BA, wherein the polymer comprises or consists of a linear unit LU comprising at least one fluorinated unit FU and at least one cationic unit CU and optionally at least one bifunctional aromatic moiety BA, or the polymer comprises or consists of a branched unit BU comprising three or more linear units LU connected through at least one branching unit reagent BUR or the polymer comprises or consists of a crosslinking unit CLU comprising two or more linear units LU connected through at least one crosslinker CL, wherein the crosslinker CL connects two BAs or two CUs of two linear units LU.

The term fluorinated unit or FU in the context of the present specification relates to a moiety of formula (I) as described below.

The term cationic unit or CU in the context of the present specification relates to a moiety of formula B or of formula C as described below. The cationic groups within the polymer allow for the transport of anions between an anode and a cathode in an electrochemical device. Non-limiting examples for anions are OH⁻, CO₃²⁻, Br⁻ or Cl⁻. The cationic unit separates the fluorinated unit from the bifunctional aromatic moiety or from each other.

The term bifunctional aromatic moiety or BA in the context of the present specification relates to a moiety that comprises 2 to 5, particularly 2 to 3, cyclic hydrocarbon moieties. Non-limiting examples are biphenyl, terphenyl (particularly para- or meta-terphenyl), 1,1′-methylenedibenzene, (1-methyl-1-phenyl-ethyl)benzene, 2-phenylethylbenzene, 9,9-dimethylfluorene and 9,9-dibutylfluorene. At least one, particularly all, of the cyclic hydrocarbon moieties are aromatic.

The term unit in the context of the present specification as used in linear unit, branched unit or crosslinked unit relates to a repetitive part in a polymer. The linear unit, branched unit or crosslinked unit form random polymers. In case of the linear unit the polymer is formed by [FU-CU]ₘ BA-CU]ₙ or [FU-CU] parts wherein m and n relates to the molar ratio of these parts, however, the order within the linear unit is randomly formed, e.g. -FU-CU-FU-CU-BA-CU-BA-CU-FU-CU-BA-CU-BA-CU-BA-CU-.

The terms C₁-C₁₀ alkyl, C₁-C₁₀ alkenyl and C₁-C₁₀ alkynyl in the context of the present specification relates to a saturated linear or branched hydrocarbon or unsaturated linear or branched hydrocarbon having 1 to 10 carbon atoms. Non-limiting examples for a C₁-C₁₀ alkyl include n-hexyl, n-heptyl, n-decanyl, 3-methylbut-2-enyl, 2-methylbut-3-enyl, 3-methylbut-3-enyl, n-pentyl, 2-methylbutyl, 3-methylbutyl, 1,1-dimethylpropyl, 1,2-dimethylpropyl, 1,2-dimethylpropyl, pent-4-inyl, 3-methyl-2-pentyl, and 4-methyl-2-pentyl, n-hexyl, n-heptyl, n-decanyl, n-butyl, isobutyl, n-propyl, isopropyl, ethyl, methyl.

The term C₁-C₆ alkyl, C₁-C₆ alkenyl and C₁-C₆ alkynyl in the context of the present specification relates to a saturated linear or branched hydrocarbon or unsaturated linear or branched hydrocarbon having 1, 2, 3, 4, 5 or 6 carbon atoms. Non-limiting examples for a C₁-C₆ alkyl include the examples given for C₁-C₁₀ alkyl above. In certain embodiments, a C₅ alkyl is a pentyl or cyclopentyl moiety and a C₆ alkyl is a hexyl or cyclohexyl moiety.

The term substituted alkyl in its broadest sense refers to an alkyl as defined above in the broadest sense, which is covalently linked to an atom that is not carbon or hydrogen, particularly to an atom selected from N, F, Cl, Br and I, which itself may be—if applicable-linked to one or several other atoms of this group, or to hydrogen, or to an unsaturated or saturated hydrocarbon (alkyl or aryl in their broadest sense). In a narrower sense, substituted alkyl refers to an alkyl as defined above in the broadest sense that is substituted in one or several carbon atoms by groups selected from amine NH₂, alkylamine NHR, imide NH, alkylimide NR, amino(carboxyalkyl) NHCOR or NRCOR, fluoride F, chloride Cl, bromide Br, iodide I, wherein the R substituent as used in the current paragraph, different from other uses assigned to R in the body of the specification, is itself an unsubstituted or substituted C₁ to C₆ alkyl unless otherwise specified.

### DETAILED DESCRIPTION OF THE INVENTION

The first aspect of the invention relates to a fluorinated polyaromatic polymer comprising
at least one fluorinated unit FU of formula (I)

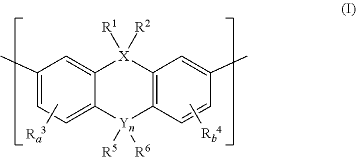

wherein
X is C or N,
Y is C,
R¹, R², R⁵ and R⁶ are independently selected from

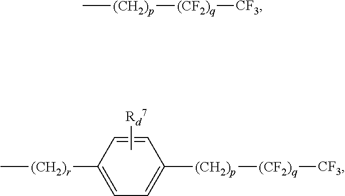

H,
—C₁-C₁₀ alkyl, wherein the —C₁-C₁₀ alkyl is substituted or unsubstituted, particularly —C₁-C₆ alkyl,
—C₂-C₁₀ alkenyl, wherein the —C₂-C₁₀ alkenyl is substituted or unsubstituted, particularly —C₂-C₆ alkenyl,
—C₂-C₁₀ alkynyl, wherein the —C₂-C₁₀ alkynyl is substituted or unsubstituted, particularly C₂-C₆ alkynyl,
wherein at least one of R¹, R², R⁵ and R⁶ is

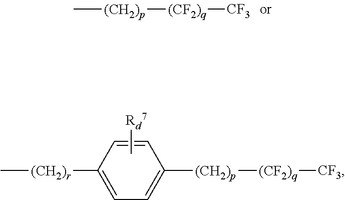

Rₐ³, R_{b}⁴ and R_{d}⁷ are independently selected from
   —C₁-C₁₀ alkyl, wherein the —C₁-C₁₀ alkyl is substituted or unsubstituted, particularly —C₁-C₆ alkyl,
   —C₂-C₁₀ alkenyl, wherein the —C₂-C₁₀ alkenyl is substituted or unsubstituted, particularly —C₂-C₆ alkenyl,
   —C₂-C₁₀ alkynyl, wherein the —C₂-C₁₀ alkynyl is substituted or unsubstituted, particularly C₂-C₆ alkynyl,
a and b are independently 0, 1, 2, or 3, particularly 0 or 1, more particularly 0,
d is 0, 1, 2, 3 or 4, particularly 0 or 1, more particularly 0,
n is 0 or 1,
r is, 1, 2, 3, 4, 5 or 6, particularly, 1, 2, or 3, more particularly 1 or 2,
p is independently between 1 and 20, particularly 1 and 15, more particularly 1 and 9, and
q is independently between 0 and 20, particularly 0 and 15, more particularly 0 and 9,
   and
at least one cationic unit CU of formula B or C

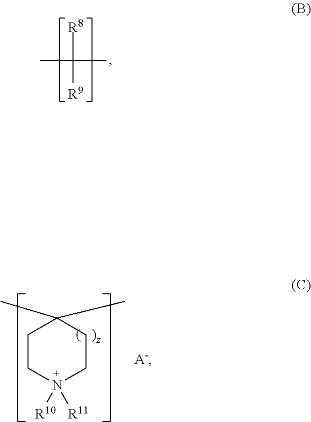

wherein
R³ is a partially or fully fluorinated C₁-C₆ alkyl, particularly CF₃,
R⁹ is selected from
   —C₁-C₁₀ alkyl, wherein the —C₁-C₁₀ alkyl is substituted or unsubstituted, particularly —C₁-C₆ alkyl,
   —C₂-C₁₀ alkenyl, wherein the —C₂-C₁₀ alkenyl is substituted or unsubstituted, particularly —C₂-C₆ alkenyl,
   —C₂-C₁₀ alkynyl, wherein the —C₂-C₁₀ alkynyl is substituted or unsubstituted, particularly C₂-C₆ alkynyl,
   —(CH₂)ₛ—N(R¹²)₂,
   —(CH₂)ₛ—NHR¹²,
   —(CH₂)ₛ—N⁺(R¹²)_{3′}
   wherein R¹² is independently selected from
      —C₁-C₁₀ alkyl, wherein the —C₁-C₁₀ alkyl is substituted or unsubstituted, particularly —C₁-C₆ alkyl,
      —C₂-C₁₀ alkenyl, wherein the —C₂-C₁₀ alkenyl substituted or unsubstituted, particularly —C₂-C₆ alkenyl,
      —C₂-C₁₀ alkynyl, wherein the —C₂-C₁₀ alkynyl is substituted or unsubstituted, particularly C₂-C₆ alkynyl,
      s is between 0 and 20
      Ph-R_{f}¹³
R¹⁰ and R¹¹ are independently selected from
   H
   —C₁-C₁₀ alkyl, wherein the —C₁-C₁₀ alkyl is substituted or unsubstituted, particularly —C₁-C₆ alkyl,
   —C₂-C₁₀ alkenyl, wherein the —C₂-C₁₀ alkenyl is substituted or unsubstituted, particularly —C₂-C₆ alkenyl,
   —C₂-C₁₀ alkynyl, wherein the —C₂-C₁₀ alkynyl is substituted or unsubstituted, particularly C₂-C₆ alkynyl,
or R¹⁰ and R¹¹ are connected to each other to form a cycloalkyl comprising
4 to 10 C atoms,
z is 0 or 1,
A⁻ is an anion.

In certain embodiments, the at least one fluorinated unit FU of formula (II)

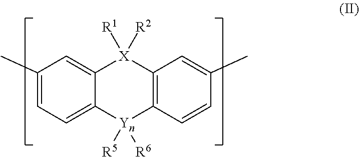

wherein
X is C or N,
Y is C,
R¹, R², R⁵ and R⁶ are independently selected from

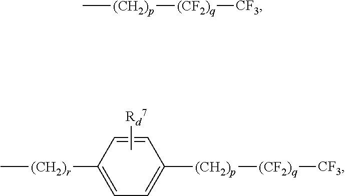

H,
—C₁-C₁₀ alkyl, wherein the —C₁-C₁₀ alkyl is substituted or unsubstituted, particularly —C₁-C₆ alkyl,
—C₂-C₁₀ alkenyl, wherein the —C₂-C₁₀ alkenyl is substituted or unsubstituted, particularly —C₂-C₆ alkenyl,
—C₂-C₁₀ alkynyl, wherein the —C₂-C₁₀ alkynyl is substituted or unsubstituted, particularly C₂-C₆ alkynyl,
wherein at least one of R¹, R², R⁵ and R⁶ is

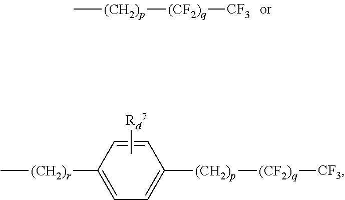

n is 0 or 1,
r is, 1, 2, 3, 4, 5 or 6, particularly, 1, 2, or 3, more particularly 1 or 2,
p is independently between 1 and 20, particularly 1 and 15, more particularly 1 and 9, and
q is independently between 0 and 20, particularly 0 and 15, more particularly 0 and 9.

In certain embodiments, R¹, R², R⁵ and R⁶ are independently selected from —C₁-C₁₀ alkyl, wherein the —C₁-C₁₀ alkyl is substituted or unsubstituted.

In certain embodiments, R¹, R², R⁵ and R⁶ are independently selected from —C₁-C₆ alkyl, wherein the —C₁-C₆ alkyl is substituted or unsubstituted.

In certain embodiments, R¹, R², R⁵ and R⁶ are independently selected from —C₁-C₆ alkyl, wherein the —C₁-C₆ alkyl is unsubstituted.

In certain embodiments z is 1.

In certain embodiments, R⁹ is selected from
—C₁-C₁₀ alkyl, wherein the —C₁-C₁₀ alkyl is substituted or unsubstituted, particularly —C₁-C₆ alkyl,
—C₂-C₁₀ alkenyl, wherein the —C₂-C₁₀ alkenyl is substituted or unsubstituted, particularly —C₂-C₆ alkenyl,
—C₂-C₁₀ alkynyl, wherein the —C₂-C₁₀ alkynyl is substituted or unsubstituted, particularly C₂-C₆ alkynyl.

In certain embodiments, R⁹ is selected from —C₁-C₁₀ alkyl, wherein the —C₁-C₁₀ alkyl is substituted or unsubstituted.

In certain embodiments, R⁹ is selected from —C₁-C₆ alkyl, wherein the —C₁-C₆ alkyl is substituted or unsubstituted.

In certain embodiments, R⁹ is selected from —C₁-C₆ alkyl, wherein the —C₁-C₆ alkyl is unsubstituted.

In certain embodiments, R⁹ is selected from —C₁-C₃ alkyl, wherein the —C₁-C₃ alkyl is unsubstituted.

In certain embodiments R¹⁰ and R¹¹ are independently selected from
H
—C₁-C₁₀ alkyl, wherein the —C₁-C₁₀ alkyl is substituted or unsubstituted, particularly —C₁-C₆ alkyl.

In certain embodiments R¹⁰ and R¹¹ are independently selected from
H
—C₁-C₆ alkyl, wherein the —C₁-C₆ alkyl is unsubstituted.

In certain embodiments R¹⁰ and R¹¹ are independently selected from
H
—C₁-C₃ alkyl, wherein the —C₁-C₃ alkyl is unsubstituted.

In certain embodiments R¹⁰ and R¹¹ are independently selected from —H and -Me.

In certain embodiments, the fluorinated polyaromatic polymer comprises at least one bifunctional aromatic moiety BA, wherein the BA is independently selected from a moiety comprising 2 to 5, particularly 2 to 3 cyclic hydrocarbon moieties, wherein the BA is unsubstituted or substituted by one or more substituents independently selected from —C₁-C₁₀-alkyl, —C₁-C₁₀-alkenyl or —C₁-C₁₀-alkynyl, particularly —C₁-C₆ alkyl, —C₂-C₆ alkenyl or —C₂-C₆ alkynyl, wherein the one or more substituent is unsubstituted or further substituted with one or more halogen atoms or one or more quaternary amines.

Additionally to having the fluorinated polyaromatic polymer comprising or consisting of [FU-CU] the fluorinated polyaromatic polymer can comprise the bifunctional aromatic moiety BA.

In certain embodiments, the BA is unsubstituted or substituted by one or more substituents independently selected from —C₁-C₆ alkyl, wherein the —C₁-C₆ alkyl is unsubstituted or further substituted with one or more halogen atoms or one or more quaternary amines.

In certain embodiments, the BA is substituted by one or more —C₁-C₆ alkyl, wherein the one or more —C₁-C₆ alkyl is further substituted with one or more quaternary amines.

In certain embodiments, the BA is unsubstituted.

In certain embodiments, the fluorinated polyaromatic polymer is ordered in such way, that FU and BA are separated by CU.

In certain embodiments, the fluorinated polyaromatic polymer according to any of the preceding claims, comprising at least one linear unit LU comprising
the one or more FU and the one or more CU, or
the one or more FU, the one or more CU and the one or more BA, particularly
the one or more FU, the one or more CU and the one or more BA,
wherein the LU is arranged [FU-CU]r-[BA-CU]y,
wherein the ratio of x and y is 1:99 to 50:50.

In certain embodiments, the ratio of x and y is 5:95 to 30:70.

In certain embodiments, the ratio of x and y is 5:95 to 20:80.

In certain embodiments, three or more linear units LU form at least one branched unit BU, wherein the three or more linear units LU are connected through at least one branching unit reagent BUR, wherein the at least one BUR is independently selected from a moiety comprising 3 to 6, cyclic hydrocarbon moieties.

In certain embodiments, two or more linear units LU form at least one crosslinked unit CLU, wherein the two or more linear units LU are crosslinked through at least one crosslinker CL, wherein the at least one crosslinker CL is independently selected from an aliphatic or aromatic quaternary diamine.

The crosslinked unit CLU can crosslink two linear units via two cationic units CU or two bifunctional aromatic moieties BA.

In certain embodiments, the at least one fluorinated unit FU is independently selected from

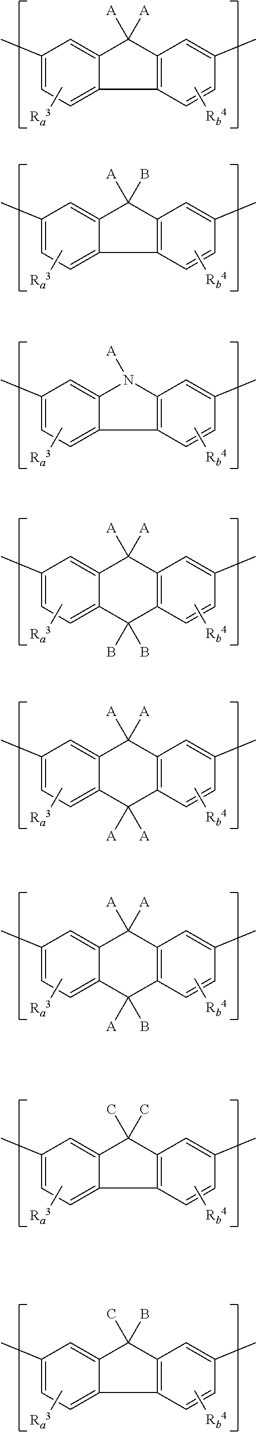

wherein
A is independently selected from —(CH₂)ₚ—(CF₂)_{q}—CF₃,
B, R³ and R⁴ are independently selected from
   —C₁-C₁₀ alkyl, wherein the —C₁-C₁₀ alkyl is substituted or unsubstituted, particularly —C₁-C₆ alkyl,
   —C₂-C₁₀ alkenyl, wherein the —C₂-C₁₀ alkenyl is substituted or unsubstituted, particularly —C₂-C₆ alkenyl,
   —C₂-C₁₀ alkynyl, wherein the —C₂-C₁₀ alkynyl is substituted or unsubstituted, particularly C₂-C₆ alkynyl,
C is independently selected from

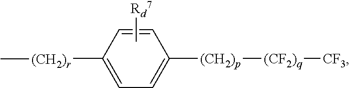

wherein R_{d}⁷ is independently selected from
   —C₁-C₁₀ alkyl, wherein the —C₁-C₁₀ alkyl is substituted or unsubstituted, particularly —C₁-C₆ alkyl,
   —C₂-C₁₀ alkenyl, wherein the —C₂-C₁₀ alkenyl is substituted or unsubstituted, particularly —C₂-C₆ alkenyl,
   —C₂-C₁₀ alkynyl, wherein the —C₂-C₁₀ alkynyl is substituted or unsubstituted, particularly C₂-C₆ alkynyl,
d is 0, 1, 2, 3 or 4,
r is, 1, 2, 3, 4, 5 or 6, particularly 1, 2 or 3, more particularly 1 or 2,
p is independently between 1 and 20, particularly 1 and 15, more particularly 1 and 9, and
q is independently between 0 and 20, particularly 0 and 15, more particularly 0 and 9,
a and b are independently 0, 1, 2, or 3.

In certain embodiments, the at least one fluorinated unit FU is independently selected from

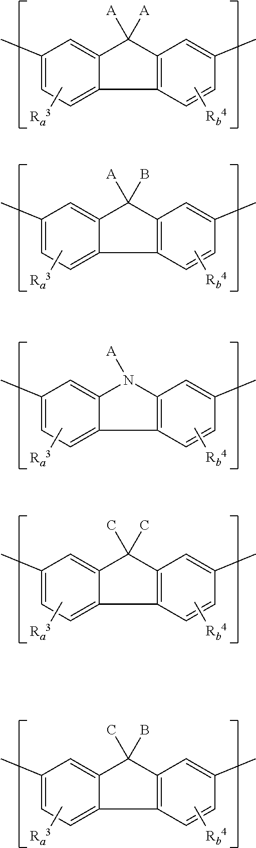

wherein
A is independently selected from —(CH₂)ₚ—(CF₂)_{q}—CF₃,
B, R³ and R⁴ are independently selected from
   —C₁-C₁₀ alkyl, wherein the —C₁-C₁₀ alkyl is substituted or unsubstituted, particularly —C₁-C₆ alkyl,
   —C₂-C₁₀ alkenyl, wherein the —C₂-C₁₀ alkenyl is substituted or unsubstituted, particularly —C₂-C₆ alkenyl,
   —C₂-C₁₀ alkynyl, wherein the —C₂-C₁₀ alkynyl is substituted or unsubstituted, particularly C₂-C₆ alkynyl,

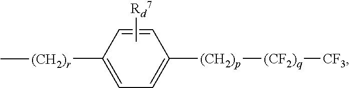

C is independently selected from
   wherein R_{d}⁷ is independently selected from
      —C₁-C₁₀ alkyl, wherein the —C₁-C₁₀ alkyl is substituted or unsubstituted, particularly —C₁-C₆ alkyl,
      —C₂-C₁₀ alkenyl, wherein the —C₂-C₁₀ alkenyl is substituted or unsubstituted, particularly —C₂-C₆ alkenyl,
      —C₂-C₁₀ alkynyl, wherein the —C₂-C₁₀ alkynyl is substituted or unsubstituted, particularly C₂-C₆ alkynyl,
   d is 0, 1, 2, 3 or 4,
   r is, 1, 2, 3, 4, 5 or 6, particularly 1, 2 or 3, more particularly 1 or 2,
p is independently between 1 and 20, particularly 1 and 15, more particularly 1 and 9, and
q is independently between 0 and 20, particularly 0 and 15, more particularly 0 and 9,
a and b are independently 0, 1, 2, or 3.

In certain embodiments, the at least one fluorinated unit FU is independently selected from

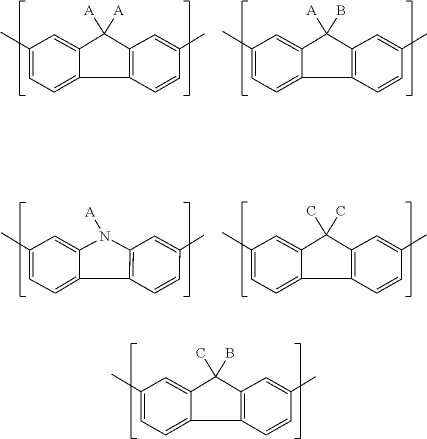

wherein
A is independently selected from —(CH₂)ₚ—(CF₂)_{q}—CF₃,
B is selected from —C₁-C₁₀ alkyl, wherein the —C₁-C₁₀ alkyl is substituted or unsubstituted, particularly —C₁-C₆ alkyl,
   —C₂-C₁₀ alkenyl, wherein the —C₂-C₁₀ alkenyl is substituted or unsubstituted, particularly —C₂-C₆ alkenyl,
   —C₂-C₁₀ alkynyl, wherein the —C₂-C₁₀ alkynyl is substituted or unsubstituted, particularly C₂-C₆ alkynyl,
C is independently selected from

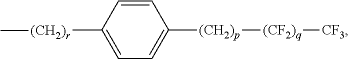

wherein
r is, 1, 2, 3, 4, 5 or 6, particularly 1, 2 or 3, more particularly 1 or 2,
p is independently between 1 and 20, particularly 1 and 15, more particularly 1 and 9, and
q is independently between 0 and 20, particularly 0 and 15, more particularly 0 and 9.

In certain embodiments, the at least one fluorinated unit FU is independently selected from

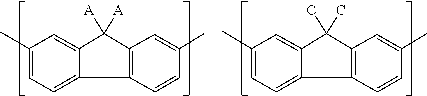

wherein
A is independently selected from —(CH₂)ₚ—(CF₂)_{q}—CF₃,
C is independently selected from

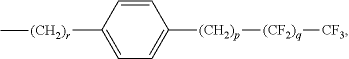

wherein
r is, 1, 2, 3, 4, 5 or 6, particularly 1, 2 or 3, more particularly 1 or 2,
p is independently between 1 and 20, particularly 1 and 15, more particularly 1 and 9, and
q is independently between 0 and 20, particularly 0 and 15, more particularly 0 and 9.

In certain embodiments, A is —(CH₂)ₚ—(CF₂)_{q}—CF₃ and
C is

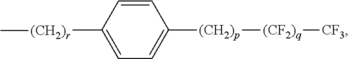

wherein
   r is, 1, 2, 3, 4, 5 or 6, particularly 1, 2 or 3, more particularly 1 or 2,
   p is between 1 and 20, particularly 1 and 15, more particularly 1 and 9, and
   q is between 0 and 20, particularly 0 and 15, more particularly 0 and 9.

In certain embodiments, the at least one fluorinated unit FU is

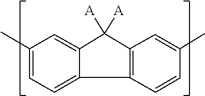

wherein
A is —(CH₂)ₚ—(CF₂)_{q}—CF₃,
p is between 1 and 20, particularly 1 and 15, more particularly 1 and 9, and
q is between 0 and 20, particularly 0 and 15, more particularly 0 and 9.

In certain embodiments, the at least one bifunctional aromatic moiety BA is independently selected from

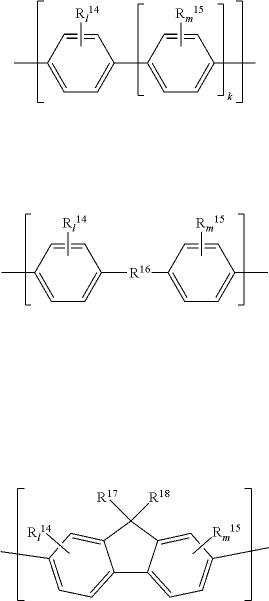

wherein
R¹⁴, R¹⁵, R¹⁶, R¹⁷ and R¹⁸ are independently selected from
   —C₁-C₁₀ alkyl, wherein the —C₁-C₁₀ alkyl is substituted or unsubstituted, particularly —C₁-C₆ alkyl,
   —C₂-C₁₀ alkenyl, wherein the —C₂-C₁₀ alkenyl is substituted or unsubstituted, particularly —C₂-C₆ alkenyl,
   —C₂-C₁₀ alkynyl, wherein the —C₂-C₁₀ alkynyl is substituted or unsubstituted, particularly C₂-C₆ alkynyl,
l and m are independently 0, 1, 2, 3 or 4,
k is 0 to 4, particularly 1 to 4, more particularly 1 or 2.

In certain embodiments, the at least one bifunctional aromatic moiety BA is independently selected from

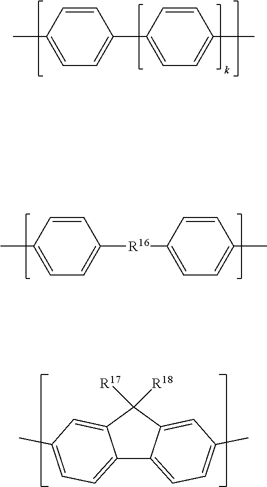

wherein
R¹⁶, R¹⁷ and R¹⁸ are independently selected from
   —C₁-C₁₀ alkyl, wherein the —C₁-C₁₀ alkyl is substituted or unsubstituted, particularly —C₁-C₆ alkyl,
   —C₂-C₁₀ alkenyl, wherein the —C₂-C₁₀ alkenyl is substituted or unsubstituted, particularly —C₂-C₆ alkenyl,
   —C₂-C₁₀ alkynyl, wherein the —C₂-C₁₀ alkynyl is substituted or unsubstituted, particularly C₂-C₆ alkynyl,
k is 0 to 4, particularly 1 to 4, more particularly 1 or 2.

In certain embodiments, the at least one bifunctional aromatic moiety BA is independently selected from

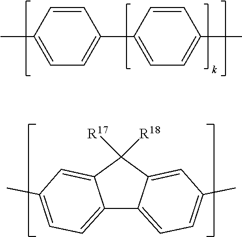

wherein
R¹⁷ and R¹⁸ are independently selected from
   —C₁-C₁₀ alkyl, wherein the —C₁-C₁₀ alkyl is substituted or unsubstituted, particularly —C₁-C₆ alkyl,
   —C₂-C₁₀ alkenyl, wherein the —C₂-C₁₀ alkenyl is substituted or unsubstituted, particularly —C₂-C₆ alkenyl,
   —C₂-C₁₀ alkynyl, wherein the —C₂-C₁₀ alkynyl is substituted or unsubstituted, particularly C₂-C₆ alkynyl,
k is 0 to 4, particularly 1 to 4, more particularly 1 or 2.

In certain embodiments, R¹⁷ and R¹⁸ are independently selected from —C₁-C₁₀ alkyl, wherein the —C₁-C₁₀ alkyl is substituted or unsubstituted.

In certain embodiments, R¹⁷ and R¹⁸ are independently selected from —C₁-C₆ alkyl, wherein the —C₁-C₆ alkyl is substituted with a halogen or quaternary amine.

In certain embodiments, R¹⁷ and R¹⁸ are equally selected from —C₁-C₆ alkyl, wherein the —C₁-C₆ alkyl is substituted with a halogen or quaternary amine.

In certain embodiments, R¹⁷ and R¹⁸ are equally selected from —C₁-C₆ alkyl, wherein the —C₁-C₆ alkyl is substituted with a bromide or NMe₃⁺OH⁻.

In certain embodiments, the at least one bifunctional aromatic moiety BA is independently selected from

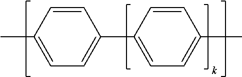

wherein
k is 0 to 4, particularly 1 to 4, more particularly 1 or 2.

In certain embodiments k is 2.

In certain embodiments, the at least one branching unit BU is independently selected from

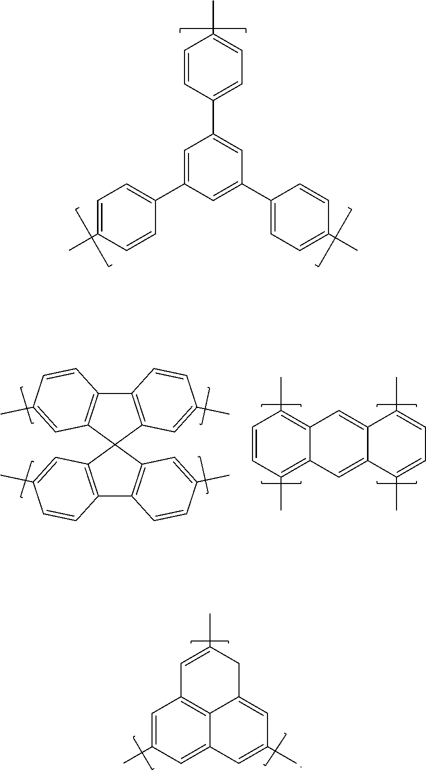

In certain embodiments, the at least one crosslinking unit CLU is independently selected from

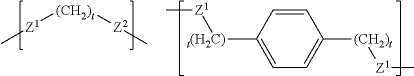

wherein
Z¹ is R¹⁹R²⁰ or NR²¹R²²,
Z² is R¹⁹R²⁰ or N⁺R²¹R²²R²³,
R¹⁹ and R²⁰ are independently selected from
   the group of halogens
   —C₁-C₁₀ alkyl, wherein the —C₁-C₁₀ alkyl is substituted or unsubstituted, particularly —C₁-C₆ alkyl,
   —C₂-C₁₀ alkenyl, wherein the —C₂-C₁₀ alkenyl is substituted or unsubstituted, particularly —C₂-C₆ alkenyl,
—C₂-C₁₀ alkynyl, wherein the —C₂-C₁₀ alkynyl is substituted or unsubstituted, particularly C₂-C₆ alkynyl,
R²¹, R²² and R²³ are independently selected from
   H
   —C₁-C₁₀ alkyl, wherein the —C₁-C₁₀ alkyl is substituted or unsubstituted, particularly —C₁-C₆ alkyl,
   —C₂-C₁₀ alkenyl, wherein the —C₂-C₁₀ alkenyl is substituted or unsubstituted, particularly —C₂-C₆ alkenyl,
   —C₂-C₁₀ alkynyl, wherein the —C₂-C₁₀ alkynyl is substituted or unsubstituted, particularly C₂-C₆ alkynyl,
t is between 0 and 20, particularly 0 to 12, more particularly 0 to 6.

In certain embodiments, R¹⁹ and R²⁰ independently selected from the group of halogens or —C₁-C₁₀ alkyl, wherein the —C₁-C₁₀ alkyl is substituted or unsubstituted.

In certain embodiments, R¹⁹ and R²⁰ independently selected from the group of halogens or —C₁-C₆ alkyl, wherein the —C₁-C₆ alkyl is substituted or unsubstituted.

In certain embodiments R²¹, R²² and R²³ are independently selected from H or —C₁-C₁₀ alkyl, wherein the —C₁-C₁₀ alkyl is substituted or unsubstituted.

In certain embodiments R²¹, R²² and R²³ are independently selected from H or —C₁-C₆ alkyl, wherein the —C₁-C₆ alkyl is substituted or unsubstituted.

In certain embodiments, the fluorine content of the fluorinated polyaromatic polymer is 2.5% to 80%.

In certain embodiments, the fluorine content of the fluorinated polyaromatic polymer is 5% to 60%.

Varying the fluorine content to above 5% increases the hydrophobicity of the polymer resulting in improved mechanical properties, such as improved alkaline and oxidation stability and tensile and swelling strength

In certain embodiments, the fluorine content of the fluorinated polyaromatic polymer is 5 to 30%.

In certain embodiments, the alkaline stability of the fluorinated polyaromatic polymer is above 2000 h in 3 M KOH at 80° C.

In certain embodiments, the oxidation stability of the fluorinated polyaromatic polymer is above 1000 h in 3% H₂O₂ Fenton solution.

In certain embodiments, the tensile strength of the fluorinated polyaromatic polymer is above 80 MPa.

In certain embodiments, the swelling strength of the fluorinated polyaromatic polymer is less than 30%.

In certain embodiments, the swelling strength of the fluorinated polyaromatic polymer is less than 15%.

The second aspect of the invention relates to a method for preparing a fluorinated polyaromatic polymer comprising one or more linear units LU comprising reacting at least one fluorinated unit precursor FUP and at least one cationic unit precursor CUP and optionally at least one bifunctional aromatic moiety precursor BAP.

In certain embodiments, the method for preparing the fluorinated polyaromatic polymer comprising one or more linear units comprising at least one fluorinated unit FU, at least one cationic unit CU and optionally at least one bifunctional aromatic moiety BA, comprising the steps of reacting the at least one fluorinate unit precursor FUP, the at least one cationic unit precursor CUP and optionally the at least one bifunctional moiety precursor BAP forming a piperidine-functionalised and/or halogen functionalised intermediate fluorinated polyaromatic polymer, polymerisation, forming a polymer membrane and forming an anion exchange membrane.

The third aspect of the invention relates to a method for preparing a fluorinated polyaromatic polymer comprising a branched unit BU comprising three or more linear units LU connected through a branching unit reagent BUR, comprising reacting at least one fluorinated unit precursor FUP and at least one cationic unit precursor CUP and optionally at least one bifunctional aromatic moiety precursor BAP and a branching unit precursor BUP.

In certain embodiments the method for preparing a fluorinated polyaromatic polymer comprising a branched unit BU comprising three or more linear units LU connected through a branching unit precursor BUP, comprising the steps of reacting at least one fluorinated unit precursor FUP and at least one cationic unit precursor CUP and optionally at least one bifunctional aromatic moiety precursor BAP and at least one branching unit precursor BUP forming a piperidine-functionalised intermediate fluorinated polyaromatic polymer and/or halogen functionalised intermediate fluorinated polyaromatic polymer, alkylation of the piperidine-functionalised intermediate fluorinated polyaromatic polymer and/or amination of the halogen functionalised intermediate fluorinated polyaromatic polymer, polymerisation, forming a polymer membrane and forming an anion exchange membrane.

The fourth aspect of the invention relates to a method for preparing a fluorinated polyaromatic polymer comprising a crosslinking unit CLU comprising two or more linear units LU connected through one or more crosslinkers CL comprising
reacting at least one fluorinated unit precursor FUP and at least one cationic unit precursor CUP and optionally at least one bifunctional aromatic moiety precursor BAP yielding an intermediate polymer, and
reacting the intermediate polymer with at least one crosslinking unit precursor CLUP.

In certain embodiments, the method for preparing a fluorinated polyaromatic polymer comprising a crosslinking unit CLU further comprising the steps of forming a polymer solution, forming a polymer membrane and forming an anion exchange membrane.

In certain embodiments, the fluorinated unit precursor FUP is selected from

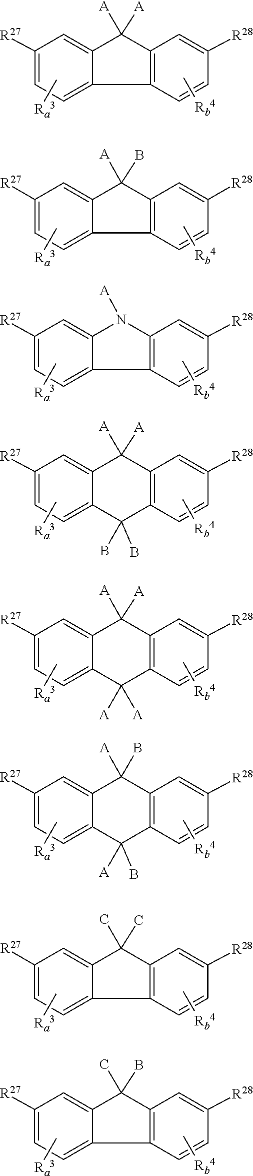

wherein
A is independently selected from —(CH₂)ₚ—(CF₂)_{q}—CF₃,
B, R³, R⁴, R²⁷ and R²⁸ are independently selected from
   —C₁-C₁₀ alkyl, wherein the —C₁-C₁₀ alkyl is substituted or unsubstituted, particularly —C₁-C₆ alkyl,
   —C₂-C₁₀ alkenyl, wherein the —C₂-C₁₀ alkenyl is substituted or unsubstituted, particularly —C₂-C₆ alkenyl,
   —C₂-C₁₀ alkynyl, wherein the —C₂-C₁₀ alkynyl is substituted or unsubstituted, particularly C₂-C₆ alkynyl,
C is independently selected from

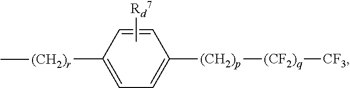

wherein R⁷ is independently selected from
   —C₁-C₁₀ alkyl, wherein the —C₁-C₁₀ alkyl is substituted or unsubstituted, particularly —C₁-C₆ alkyl,
   —C₂-C₁₀ alkenyl, wherein the —C₂-C₁₀ alkenyl is substituted or unsubstituted, particularly —C₂-C₆ alkenyl,
   —C₂-C₁₀ alkynyl, wherein the —C₂-C₁₀ alkynyl is substituted or unsubstituted, particularly C₂-C₆ alkynyl,
d is 0, 1, 2, 3 or 4,
r is 0, 1 or 2,
p is independently between 1 and 20, particularly 1 and 15, more particularly 1 and 9, and
q is independently between 0 and 20, particularly 0 and 15, more particularly 0 and 9,
a and b are independently 0, 1, 2, or 3.

In certain embodiments, the fluorinated unit precursor FUP is selected from

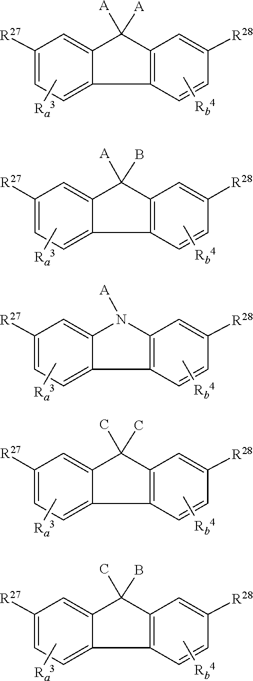

wherein
A is independently selected from —(CH₂)ₚ—(CF₂)_{q}—CF₃,
B, R³, R⁴, R²⁷ and R²⁸ are independently selected from
   —C₁-C₁₀ alkyl, wherein the —C₁-C₁₀ alkyl is substituted or unsubstituted, particularly —C₁-C₆ alkyl,
   —C₂-C₁₀ alkenyl, wherein the —C₂-C₁₀ alkenyl is substituted or unsubstituted, particularly —C₂-C₆ alkenyl,
   —C₂-C₁₀ alkynyl, wherein the —C₂-C₁₀ alkynyl is substituted or unsubstituted, particularly C₂-C₆ alkynyl,
C is independently selected from

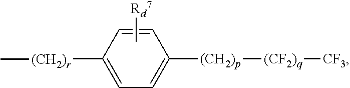

wherein R_{d}⁷ is independently selected from
   —C₁-C₁₀ alkyl, wherein the —C₁-C₁₀ alkyl is substituted or unsubstituted, particularly —C₁-C₆ alkyl,
   —C₂-C₁₀ alkenyl, wherein the —C₂-C₁₀ alkenyl is substituted or unsubstituted, particularly —C₂-C₆ alkenyl,
   —C₂-C₁₀ alkynyl, wherein the —C₂-C₁₀ alkynyl is substituted or unsubstituted, particularly C₂-C₆ alkynyl,
d is 0, 1, 2, 3 or 4,
r is, 1, 2, 3, 4, 5 or 6, particularly 1, 2 or 3, more particularly 1 or 2,
p is independently between 1 and 20, particularly 1 and 15, more particularly 1 and 9, and
q is independently between 0 and 20, particularly 0 and 15, more particularly 0 and 9,
a and b are independently 0, 1, 2, or 3.

In certain embodiments, the fluorinated unit precursor FUP is selected from

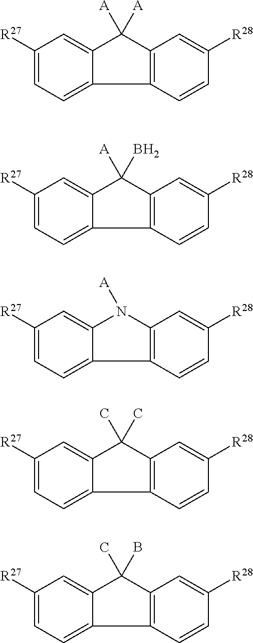

wherein
A is independently selected from —(CH₂)ₚ—(CF₂)_{q}—CF₃,
B, R²⁷ and R²⁸ are independently selected from
   —C₁-C₁₀ alkyl, wherein the —C₁-C₁₀ alkyl is substituted or unsubstituted, particularly —C₁-C₆ alkyl,
   —C₂-C₁₀ alkenyl, wherein the —C₂-C₁₀ alkenyl is substituted or unsubstituted, particularly —C₂-C₆ alkenyl,
   —C₂-C₁₀ alkynyl, wherein the —C₂-C₁₀ alkynyl is substituted or unsubstituted, particularly C₂-C₆ alkynyl,
C is independently selected from

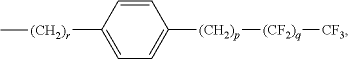

wherein
p is independently between 1 and 20, particularly 1 and 15, more particularly 1 and 9, and
q is independently between 0 and 20, particularly 0 and 15, more particularly 0 and 9
r is, 1, 2, 3, 4, 5 or 6, particularly 1, 2 or 3, more particularly 1 or 2.

In certain embodiments, the fluorinated unit precursor FUP is selected from

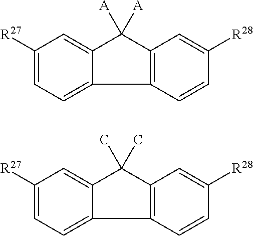

wherein
A is independently selected from —(CH₂)ₚ—(CF₂)_{q}—CF₃,
R²⁷ and R²⁸ are independently selected from
   —C₁-C₁₀ alkyl, wherein the —C₁-C₁₀ alkyl is substituted or unsubstituted, particularly —C₁-C₆ alkyl,
   —C₂-C₁₀ alkenyl, wherein the —C₂-C₁₀ alkenyl is substituted or unsubstituted, particularly —C₂-C₆ alkenyl,
   —C₂-C₁₀ alkynyl, wherein the —C₂-C₁₀ alkynyl is substituted or unsubstituted, particularly C₂-C₆ alkynyl,
C is independently selected from

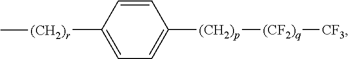

wherein
r is, 1, 2, 3, 4, 5 or 6, particularly 1, 2 or 3, more particularly 1 or 2,
p is independently between 1 and 20, particularly 1 and 15, more particularly 1 and 9, and
q is independently between 0 and 20, particularly 0 and 15, more particularly 0 and 9.

In certain embodiments, R²⁷ and R²⁸ are selected from —C¹-C¹⁰ alkyl, wherein the —C¹-C¹⁰ alkyl is substituted or unsubstituted.

In certain embodiments, R²⁷ and R²⁸ are selected from —C¹-C⁶ alkyl, wherein the —C₁-C⁶ alkyl is substituted or unsubstituted.

In certain embodiments, R²⁷ and R²⁸ are selected from —C¹-C⁶ alkyl, wherein the —C¹-C⁶ alkyl is unsubstituted.

In certain embodiments, A is —(CH₂)ₚ—(CF₂)_{q}—CF₃ and
C is

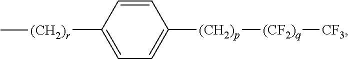

wherein
r is, 1, 2, 3, 4, 5 or 6, particularly 1, 2 or 3, more particularly 1 or 2,
p is between 1 and 20, particularly 1 and 15, more particularly 1 and 9, and
q is between 0 and 20, particularly 0 and 15, more particularly 0 and 9.

In certain embodiments, the fluorinated unit precursor FUP is selected from

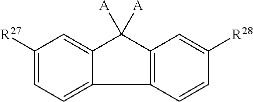

wherein
A is —(CH₂)ₚ—(CF₂)_{q}—CF₃ and
R²⁷ and R²⁸ are —C¹-C⁶ alkyl, wherein the —C¹-C⁶ alkyl is unsubstituted.

In certain embodiments, the cationic unit precursor CUP is selected from

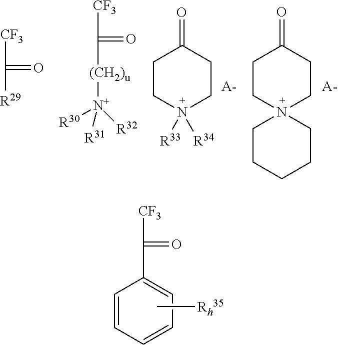

wherein
R²⁹, R³⁰, R³¹, R³², R³³, R³⁴ and R³⁵ are independently selected from
   H
   —C₁-C₁₀ alkyl, wherein the —C₁-C₁₀ alkyl is substituted or unsubstituted, particularly —C₁-C₆ alkyl,
   —C₂-C₁₀ alkenyl, wherein the —C₂-C₁₀ alkenyl is substituted or unsubstituted, particularly —C₂-C₆ alkenyl,
   —C₂-C₁₀ alkynyl, wherein the —C₂-C₁₀ alkynyl is substituted or unsubstituted, particularly C₂-C₆ alkynyl,
h is 0, 1, 2, 3, 4 or 5,
u is 0, 1, 2 or 3,
A⁻ is an anion.

In certain embodiments, the cationic unit precursor CUP is selected from

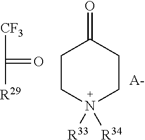

wherein
R²⁹, R³³ and R³⁴ are independently selected from
   H
   —C₁-C₁₀ alkyl, wherein the —C₁-C₁₀ alkyl is substituted or unsubstituted, particularly —C₁-C₆ alkyl,
   —C₂-C₁₀ alkenyl, wherein the —C₂-C₁₀ alkenyl is substituted or unsubstituted, particularly —C₂-C₆ alkenyl,
   —C₂-C₁₀ alkynyl, wherein the —C₂-C₁₀ alkynyl is substituted or unsubstituted, particularly C₂-C₆ alkynyl,
A⁻ is an anion.

In certain embodiments, R²⁹, R³³ and R³⁴ are independently selected from
H
—C₁-C₁₀ alkyl, wherein the —C₁-C₁₀ alkyl is substituted or unsubstituted.

In certain embodiments, R²⁹, R³³ and R³⁴ are independently selected from
H
—C₁-C₆ alkyl, wherein the —C₁-C₆ alkyl is unsubstituted.

In certain embodiments, the bifunctional aromatic moiety precursor BAP is selected from

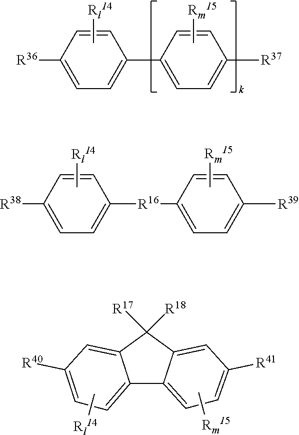

wherein
R¹⁴, R¹⁵, R¹⁶, R¹⁷, R¹⁸, R³⁶, R³⁷, R³⁸, R³⁹, R⁴⁰ and R⁴¹ are independently selected from
   —C₁-C₁₀ alkyl, wherein the —C₁-C₁₀ alkyl is substituted or unsubstituted, particularly —C₁-C₆ alkyl,
   —C₂-C₁₀ alkenyl, wherein the —C₂-C₁₀ alkenyl is substituted or unsubstituted, particularly —C₂-C₆ alkenyl,
   —C₂-C₁₀ alkynyl, wherein the —C₂-C₁₀ alkynyl is substituted or unsubstituted, particularly C₂-C₆ alkynyl,
l and m are 0, 1, 2, 3 or 4,
k is 0 to 4, particularly 1 to 4, more particularly 1 or 2.

In certain embodiments, the bifunctional aromatic moiety precursor BAP is selected from

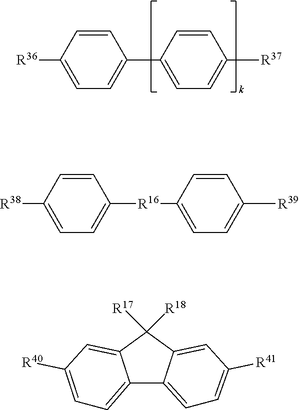

wherein
R¹⁶, R¹⁷, R¹⁸, R³⁶, R³⁷, R³⁸, R³⁹, R⁴⁰ and R⁴¹ are independently selected from
   —C₁-C₁₀ alkyl, wherein the —C₁-C₁₀ alkyl is substituted or unsubstituted, particularly —C₁-C₆ alkyl,
   —C₂-C₁₀ alkenyl, wherein the —C₂-C₁₀ alkenyl is substituted or unsubstituted, particularly —C₂-C₆ alkenyl,
   —C₂-C₁₀ alkynyl, wherein the —C₂-C₁₀ alkynyl is substituted or unsubstituted, particularly C₂-C₆ alkynyl,
k is 0 to 4, particularly 1 to 4, more particularly 1 or 2.

In certain embodiments, the bifunctional aromatic moiety precursor BAP is selected from

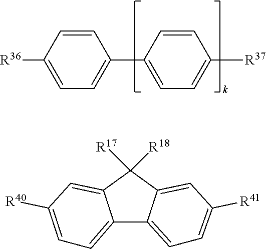

wherein
R¹⁷, R¹⁸, R³⁶, R³⁷, R⁴⁰ and R⁴¹ are independently selected from
   —C₁-C₁₀ alkyl, wherein the —C₁-C₁₀ alkyl is substituted or unsubstituted, particularly —C₁-C₆ alkyl,
   —C₂-C₁₀ alkenyl, wherein the —C₂-C₁₀ alkenyl is substituted or unsubstituted, particularly —C₂-C₆ alkenyl,
   —C₂-C₁₀ alkynyl, wherein the —C₂-C₁₀ alkynyl is substituted or unsubstituted, particularly C₂-C₆ alkynyl,
k is 0 to 4, particularly 1 to 4, more particularly 1 or 2.

In certain embodiments, R¹⁷, R¹⁸, R³⁶, R³⁷, R⁴⁰ and R⁴¹ are independently selected from —C₁-C₁₀ alkyl, wherein the —C₁-C₁₀ alkyl is substituted or unsubstituted.

In certain embodiments, R¹⁷ and R¹⁸ are independently selected from —C₁-C₆ alkyl, wherein the —C₁-C₆ alkyl is substituted with a halogen or quaternary amine.

In certain embodiments, R¹⁷ and R¹⁸ are equally selected from —C₁-C₆ alkyl, wherein the —C₁-C₆ alkyl is substituted with a halogen or quaternary amine.

In certain embodiments, R³⁶, R³⁷, R⁴⁰ and R⁴¹ are independently selected from —C₁-C₆ alkyl, wherein the —C₁-C₆ alkyl is unsubstituted.

In certain embodiments, the bifunctional aromatic moiety precursor BAP is selected from

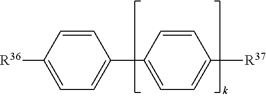

wherein
R³⁶ and R³⁷ are independently selected from —C₁-C₆ alkyl, wherein the —C₁-C₆ alkyl is unsubstituted.
k is 0 to 4, particularly 1 to 4, more particularly 1 or 2.

In certain embodiments, k is 2.

In certain embodiments the crosslinker CL is selected from

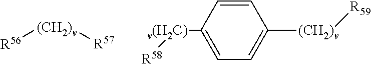

wherein
R⁵⁶, R⁵⁷, R⁵⁸ and R⁵⁹ are independently selected from
   the group of halogens,
   —C₁-C₁₀ alkyl, wherein the —C₁-C₁₀ alkyl is substituted or unsubstituted, particularly —C₁-C₆ alkyl,
   —C₂-C₁₀ alkenyl, wherein the —C₂-C₁₀ alkenyl is substituted or unsubstituted, particularly —C₂-C₆ alkenyl,
   —C₂-C₁₀ alkynyl, wherein the —C₂-C₁₀ alkynyl is substituted or unsubstituted, particularly C₂-C₆ alkynyl,
v is independently between 0 and 20.

In certain embodiments, R⁵⁶, R⁵⁷, R⁵⁸ and R⁵⁹ are independently selected from the group of halogens and —C₁-C₁₀ alkyl, wherein the —C₁-C₁₀ alkyl is substituted or unsubstituted.

In certain embodiments, R⁵⁶, R⁵⁷, R⁵⁸ and R⁵⁹ are independently selected from the group of halogens and —C₁-C₆ alkyl, wherein the —C₁-C₆ alkyl is substituted or unsubstituted.

In certain embodiments, R⁵⁶, R⁵⁷, R⁵⁸ and R⁵⁹ are independently selected from the group of halogens and —C₁-C₆ alkyl, wherein the —C₁-C₆ alkyl is unsubstituted.

In certain embodiments, the crosslinker CL is selected from

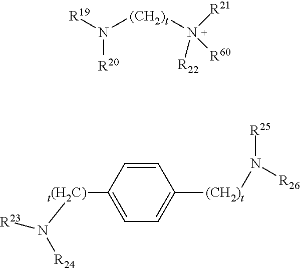

wherein
R¹⁹, R²⁰, R²¹, R²², R²³, R²⁴, R²⁴, R²⁵, R²⁶ and R⁶⁰ are independently selected from
   H,
   —C₁-C₁₀ alkyl, wherein the —C₁-C₁₀ alkyl is substituted or unsubstituted, particularly —C₁-C₆ alkyl,
   —C₂-C₁₀ alkenyl, wherein the —C₂-C₁₀ alkenyl is substituted or unsubstituted, particularly —C₂-C₆ alkenyl,
   —C₂-C₁₀ alkynyl, wherein the —C₂-C₁₀ alkynyl is substituted or unsubstituted, particularly C₂-C₆ alkynyl,
t is independently between 0 and 20.

In certain embodiments, R¹⁹, R²⁰, R²¹, R²², R²³, R²⁴, R²⁴, R²⁵, R²⁶ and R⁶⁰ are independently selected from H and —C₁-C₁₀ alkyl, wherein the —C₁-C₁₀ alkyl is substituted or unsubstituted.

In certain embodiments, R¹⁹, R²⁰, R²¹, R²², R²³, R²⁴, R²⁴, R²⁵, R²⁶ and R⁶⁰ are independently selected from H and —C₁-C₆ alkyl, wherein the —C₁-C₆ alkyl is substituted or unsubstituted.

In certain embodiments, R¹⁹, R²⁰, R²¹, R²², R²³, R²⁴, R²⁴, R²⁵, R²⁶ and R⁶⁰ are independently selected from H and —C₁-C₆ alkyl, wherein the —C₁-C₆ alkyl is unsubstituted.

The invention is further illustrated by the following examples and figures, from which further embodiments and advantages can be drawn. These examples are meant to illustrate the invention but not to limit its scope.

### DESCRIPTION OF THE FIGURES

FIG. 1 shows the alkaline stability test of PF10TP80 AEMs in 3 M KOH at 80° C.; the bottom graph represents pristine; the x-axis unit is [ppm].

FIG. 2 shows the oxidation stability test of PF10TP80 AEMs in 3% H₂O₂ at 25° C.; the bottom graph represents pristine; the x-axis unit is [ppm].

FIG. 3 shows the mechanical properties of PF10TP95 AEMs; the y-axis shows the tensile strength in [Mpa], the x-axis shows the elongation at break in [%].

FIG. 4 shows the OH⁻ conductivity of PF10TP95 AEMs; the y-axis shows the conductivity in [mS/cm], the x-axis shows the temperature in [° C.].

FIG. 5 shows the swelling ratio of PF10TP95 AEMs; the y-axis shows the swelling in [%], the x-axis shows the temperature in [° C.].

FIG. 6 shows the water uptake of PF10TP95 AEMs; the y-axis shows the water uptake in [%], the x-axis shows the temperature in [° C.].

FIG. 7 shows the structure of Nafion 117.

FIG. 8 shows the structure of PAP-TP-X (X=75-100).

FIG. 9 shows the structures of prepared AEM examples listed in table 1.

### EXAMPLES

### General Procedure

Step 1: Formation of a Piperidine-Functionalised and/or Halogen Functionalised Intermediate Fluorinated Polyaromatic Polymer

### Preparation of [FU-CU]ₓ Structured Fluorinated Polyaromatic Polymer

1 equivalent of FU and 1 equivalent of CU are dissolved in dichloromethane and stirred at 0° C. Trifluoroacetic acid (1.5 equiv.) and trifluoromethanesulfonic acid (10 equiv.) were added. After the solution became viscous, the resulting gel was slowly poured into excessive water, forming a fiber. The fiber was further washed once with a 1 M KOH solution and washed three times with water. The piperidine-functionalized and/or halogen functionalised intermediate polymer is obtained after drying under vacuum at 120° C. overnight.

### Preparation of a [FU-CU]ₓ-[BA-CU]y Structured Fluorinated Polyaromatic Polymer

0.1 to 0.2 equivalents FU, 0.8 to 0.9 equivalents BA and 1 to 1.1 equivalents CU are dissolved in dichloromethane and stirred at 0° C. Trifluoroacetic acid (1.5 equiv.) and trifluoromethanesulfonic acid (10 equiv.) were added. After the solution became viscous, the resulting gel was slowly poured into excessive water, forming a fiber. The fiber was further washed once with a 1 M KOH solution and washed three times with water. The piperidine-functionalized and/or halogen functionalised intermediate polymer is obtained after drying under vacuum at 120° C. overnight.

### Step 2: Formation of a Polymer Membrane

The piperidine-functionalized and/or halogen functionalised intermediate polymer intermediate polymer is suspended in dimethyl sulfoxide. CH3I (3 equiv. to CU) and K2CO₃ (2 equiv. to CU) were added. The solution is stirred at room temperature in a dark environment for 1 d. The resulted viscous solution was precipitated from ethyl acetate, washed with water twice, and completely dried at 80° C. under vacuum yielding the piperidinium-functionalized and/or halogen functionalised polymer.

### Step 3: Formation of an Anion Exchange Membrane (AEM)

The piperidinium-functionalized and/or halogen functionalised polymer is dissolved in dimethyl sulfoxide, filtered through a 0.45 um PTFE filter and casted onto a glass plate. AEMs (in iodide form) is peeled off from the glass plate in contact with deionized water. AEMs in halogenate ion form are obtained by ion exchanging in 1 M salts solution at 80° C. AEMs in hydroxide form is obtained by ion exchanging in 1 M KOH solution at 80° C.

### Example 1: Preparation of PF10TP80 Anion Exchange Membrane (AEM)

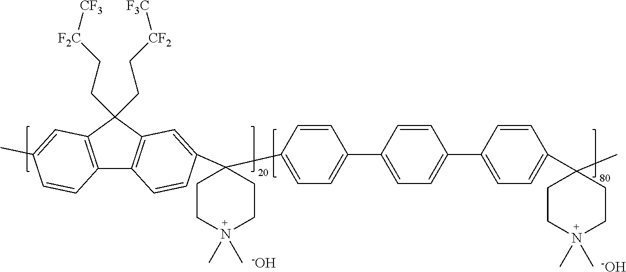

Step 1: p-terphenyl (0.8 equiv.), 9,9-bis(3,3,4,4,4-pentafluorobutyl)-9H-fluorene (0.2 equiv.), and 1-methyl-4-piperidone (1.1 equiv.) were dissolved into dichloromethane. The solution was stirred at 0° C. Trifluoroacetic acid (1.5 equiv.) and trifluoromethanesulfonic acid (10 equiv.) were added. After the solution became viscous, the resulting dark blue gel was slowly poured into excessive water, forming a white fiber. The fiber was further washed once with a 1 M KOH solution and washed three times with water. The piperidine-functionalized intermediate polymer (yield 92%) was obtained after drying under vacuum at 120° C. overnight.

Step 2: The piperidine-functionalized intermediate polymer was suspended in dimethyl sulfoxide. CH₃I (3 equiv. to piperidone group) and K₂CO₃ (2 equiv. to piperidone group) were added. The solution was stirred at room temperature in a dark environment for 1 d. The resulted viscous solution was precipitated from ethyl acetate, washed with water twice, and completely dried at 80° C. under vacuum. The yield of the piperidinium-functionalized polymer is around 100%.

Step 3: The piperidinium-functionalized polymer was dissolved in dimethyl sulfoxide, filtered through a 0.45 um PTFE filter and casted onto a glass plate. AEMs (in iodide form) were peeled off from the glass plate in contact with deionized water. AEMs in halogenate ion form were obtained by ion exchanging in 1 M salts solution at 80° C. AEMs in hydroxide form was obtained by ion exchanging in 1 M KOH solution at 80° C. The AEMs is noted as PF10TP80, where 10 refers to the number of fluorine in monomer and 80 refers to the ratio of terphenyl monomer.

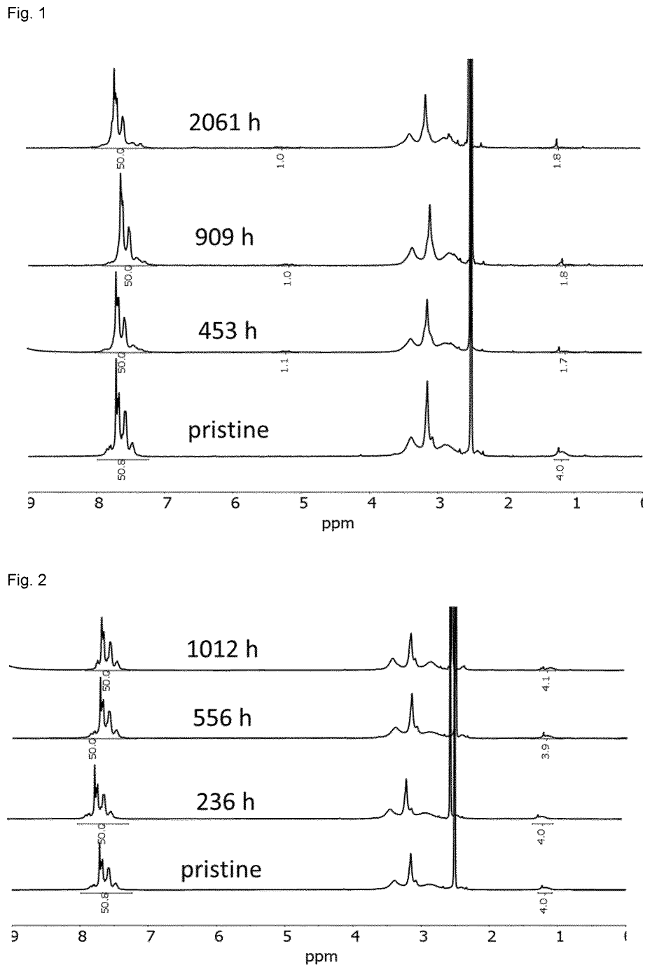

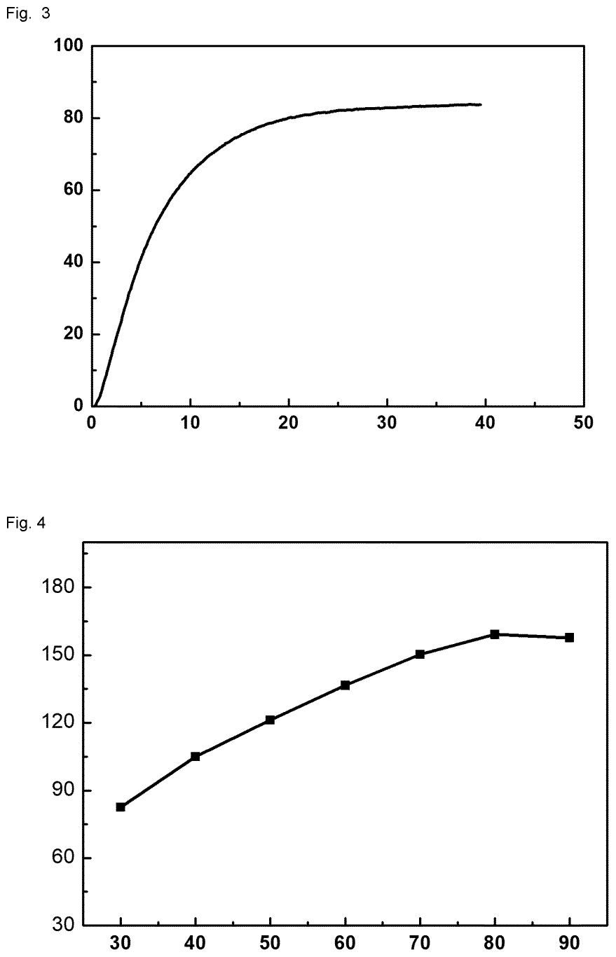

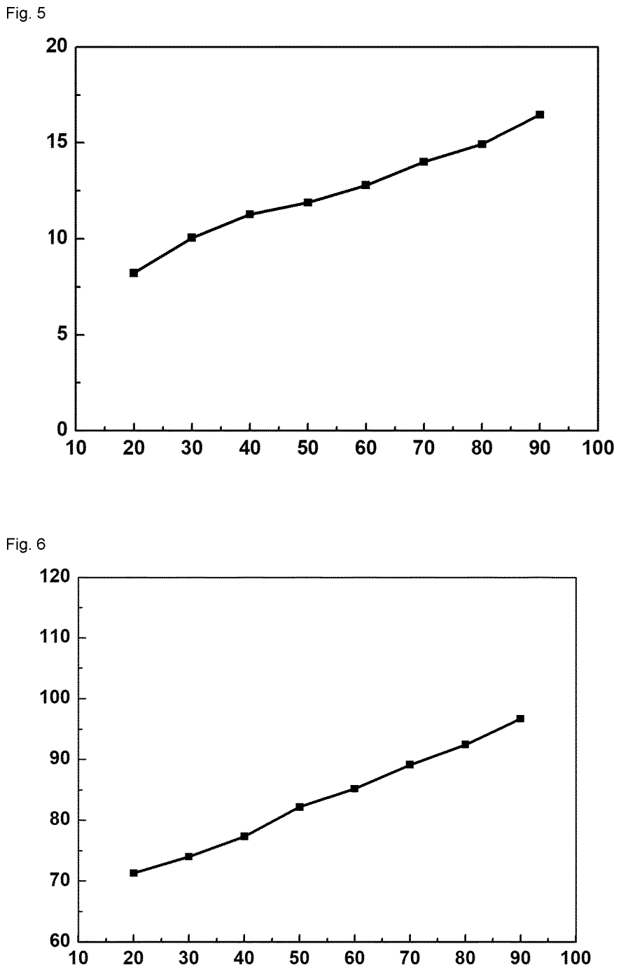

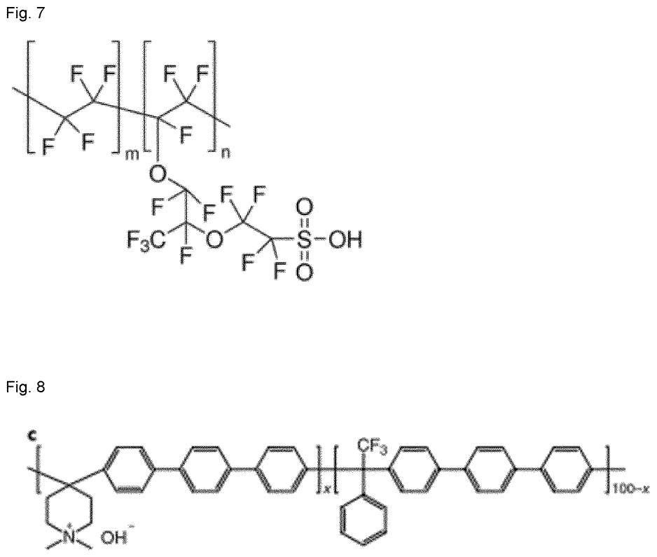

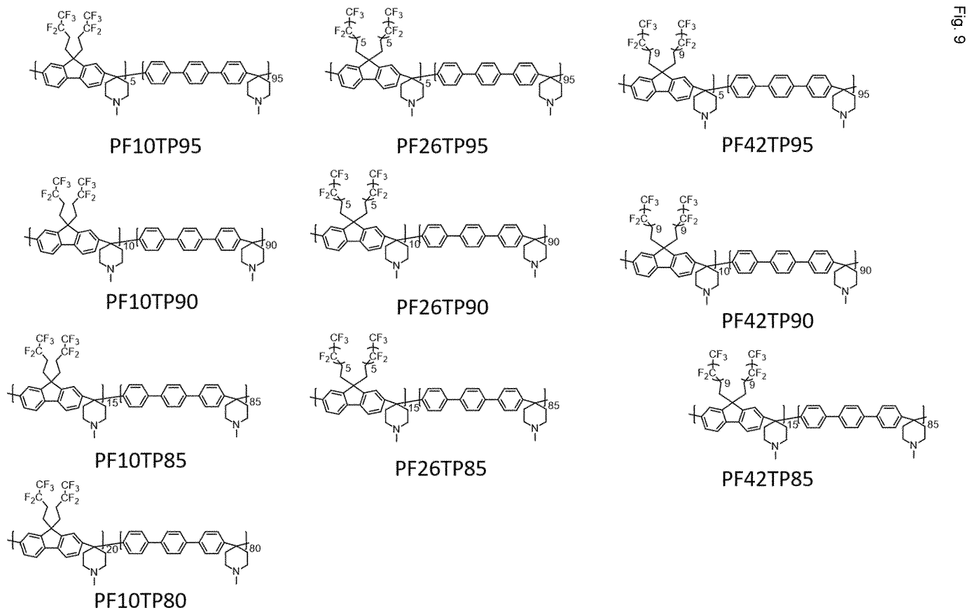

Characterization: PF10TP80 AEM showed superior alkaline stability (>2000h in 3M KOH at 80° C., FIG. 1). and oxidation stability (>1000h in Fenton solution (3 wt % H₂O₂ and 4 ppm Fe²⁺), FIG. 2). PF10TP80 AEM possessed excellent mechanical properties (tensile strength>80 MPa and elongation at break>35%), OH⁻ conductivity (>150 mS/cm at 80° C.) and dimensional stability (swelling ratio<15%, water uptake<90%).

### Example 2: Preparation of PF26TP85 Anion Exchange Membrane (AEM)

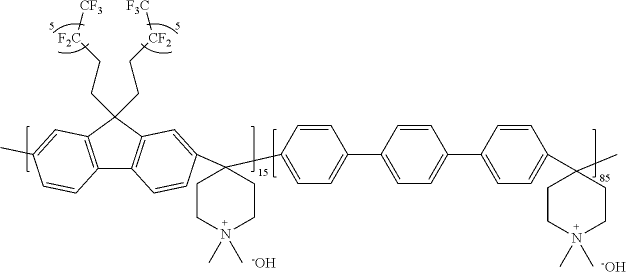

Step 1: p-terphenyl (0.85 equiv.), 9,9-bis(3,3,4,4,5,5,6,6,7,7,8,8,8-tridecafluorooctyl)-9H-fluorene (0.15 equiv.), and 1-methyl-4-piperidone (1.1 equiv.) were dissolved into dichloromethane. The solution was stirred at 0° C. Trifluoroacetic acid (1.5 equiv.) and trifluoromethanesulfonic acid (10 equiv.) were added. After the solution became viscous, the resulting dark blue gel was slowly poured into excessive water, forming a white fiber. The fiber was further washed once with a 1 M KOH solution and washed three times with water. The piperidine-functionalized intermediate polymer (yield 91%) was obtained after drying under vacuum at 120° C. overnight.

Step 2: The piperidine-functionalized intermediate polymer was suspended in dimethyl sulfoxide. CH₃I (3 equiv. to piperidone group) and K₂CO₃ (2 equiv. to piperidone group) were added. The solution was stirred at room temperature in a dark environment for 1 day. The resulted viscous solution was precipitated from ethyl acetate, washed with water twice, and completely dried at 80° C. under vacuum. The yield of the piperidinium-functionalized polymer is around 100%.

Step 3: The piperidinium-functionalized polymer was dissolved in dimethyl sulfoxide, filtered through a 0.45 um PTFE filter and casted onto a glass plate. AEMs (in iodide form) were peeled off from the glass plate in contact with deionized water. AEMs in halogenate ion form were obtained by ion exchanging in 1 M salts solution at 80° C. AEMs in hydroxide form was obtained by ion exchanging in 1 M KOH solution at 80° C. The AEMs is noted as PF26TP85, where 26 refers to the number of fluorine in monomer and 85 refers to the ratio of terphenyl monomer.

### Example 3: Preparation of PF42TP85 Anion Exchange Membrane (AEM)

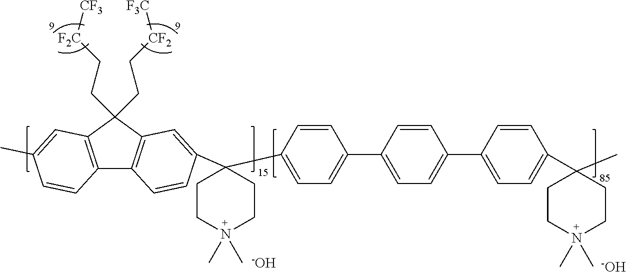

Step 1: p-terphenyl (0.85 equiv.), 9,9-bis(3,3,4,4,5,5,6,6,7,7,8,8,9,9,10,10,11,11,12,12,12-henicosafluorododecyl)-9H-fluorene (0.15 equiv.), and 1-methyl-4-piperidone (1.1 equiv.) were dissolved into dichloromethane. The solution was stirred at 0° C. Trifluoroacetic acid (1.5 equiv.) and trifluoromethanesulfonic acid (10 equiv.) were added. After the solution became viscous, the resulting dark blue gel was slowly poured into excessive water, forming a white fiber. The fiber was further washed once with a 1 M KOH solution and washed three times with water. The piperidine-functionalized intermediate polymer (yield 91%) was obtained after drying under vacuum at 120° C. overnight.

Step 2: The piperidine-functionalized intermediate polymer was suspended in dimethyl sulfoxide. CH₃I (3 equiv. to piperidone group) and K₂CO₃ (2 equiv. to piperidone group) were added. The solution was stirred at room temperature in a dark environment for 1 day. The resulted viscous solution was precipitated from ethyl acetate, washed with water twice, and completely dried at 80° C. under vacuum. The yield of the piperidinium-functionalized polymer is around 100%.

Step 3: The piperidinium-functionalized polymer was dissolved in dimethyl sulfoxide, filtered through a 0.45 um PTFE filter and casted onto a glass plate. AEMs (in iodide form) were peeled off from the glass plate in contact with deionized water. AEMs in halogenate ion form were obtained by ion exchanging in 1 M salts solution at 80° C. AEMs in hydroxide form was obtained by ion exchanging in 1 M KOH solution at 80° C. The AEMs is noted as PF42TP85, where 42 refers to the number of fluorine in monomer and 85 refers to the ratio of terphenyl monomer.

### Example 4: Preparation of PF10FA90 Anion Exchange Membrane (AEM)

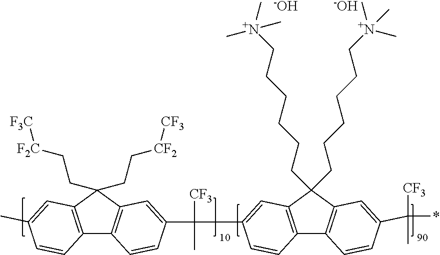

Step 1: 9,9-bis(6-bromohexyl)-9H-fluorene (0.9 equiv.), 9,9-bis(3,3,4,4,4-pentafluorobutyl)-9H-fluorene (0.1 equiv.), and 1,1,1-trifluoropropan-2-one (1.1 equiv.) were dissolved into dichloromethane. The solution was stirred at 0° C. Trifluoroacetic acid (1.5 equiv.) and trifluoromethanesulfonic acid (10 equiv.) were added. After the solution became viscous, the resulting dark blue gel was slowly poured into excessive water, forming a white fiber. The fiber was further washed once with a 1 M KOH solution and washed three times with water. The bromine-functionalized intermediate polymer (yield 93%) was obtained after drying under vacuum at 120° C. overnight.

Step 2: The bromine-functionalized intermediate polymer was dissolved in tetrahydrofuran, filtered through a 0.45 um PTFE filter and casted onto a glass plate. The membrane was peeled off from the glass plate in contact with deionized water.

Step 3: The membrane was immersed in excess 45% trimethylamine solution at room temperature in a dark environment for 2 day. The resulted AEMs was in bromine form. AEMs in halogenate ion form were obtained by ion exchanging in 1 M salts solution at 80° C. AEMs in hydroxide form was obtained by ion exchanging in 1 M KOH solution at 80° C. The AEMs is noted as PF10FA90, where 10 refers to the number of fluorine in monomer and 90 refers to the ratio of 9,9-bis(6-bromohexyl)-9H-fluorene monomer.

### Example 5: Preparation of PF26BP90 Anion Exchange Membrane (AEM)

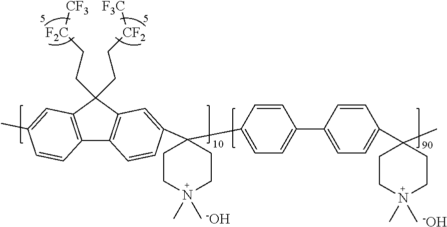

Step 1: biphenyl (0.9 equiv.), 9,9-bis(3,3,4,4,5,5,6,6,7,7,8,8,8-tridecafluorooctyl)-9H-fluorene (0.1 equiv.), and 1-methyl-4-piperidone (1.1 equiv.) were dissolved into dichloromethane. The solution was stirred at 0° C. Trifluoroacetic acid (1.5 equiv.) and trifluoromethanesulfonic acid (10 equiv.) were added. After the solution became viscous, the resulting dark blue gel was slowly poured into excessive water, forming a white fiber. The fiber was further washed once with a 1 M KOH solution and washed three times with water. The piperidine-functionalized intermediate polymer (yield 91%) was obtained after drying under vacuum at 120° C. overnight.

Step 2: The piperidine-functionalized intermediate polymer was suspended in dimethyl sulfoxide. CH₃I (3 equiv. to piperidone group) and K₂CO₃ (2 equiv. to piperidone group) were added. The solution was stirred at room temperature in a dark environment for 1 day. The resulted viscous solution was precipitated from ethyl acetate, washed with water twice, and completely dried at 80° C. under vacuum. The yield of the piperidinium-functionalized polymer is around 100%.

Step 3: The piperidinium-functionalized polymer was dissolved in dimethyl sulfoxide, filtered through a 0.45 um PTFE filter and casted onto a glass plate. AEMs (in iodide form) were peeled off from the glass plate in contact with deionized water. AEMs in halogenate ion form were obtained by ion exchanging in 1 M salts solution at 80° C. AEMs in hydroxide form was obtained by ion exchanging in 1 M KOH solution at 80° C. The AEMs is noted as PF26BP90, where 26 refers to the number of fluorine in monomer and 90 refers to the ratio of biphenyl monomer.

### Example 6: Preparation of PF6TP90 Anion Exchange Membrane (AEM)

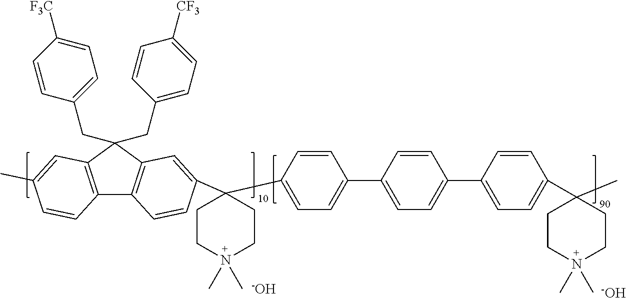

Step 1: p-terphenyl (0.9 equiv.), 9,9-bis(4-(trifluoromethyl)benzyl)-9H-fluorene, and 1-methyl-4-piperidone (1.1 equiv.) were dissolved into dichloromethane. The solution was stirred at 0° C. Trifluoroacetic acid (1.5 equiv.) and trifluoromethanesulfonic acid (10 equiv.) were added. After the solution became viscous, the resulting dark blue gel was slowly poured into excessive water, forming a white fiber. The fiber was further washed once with a 1 M KOH solution and washed three times with water. The piperidine-functionalized intermediate polymer (yield 91%) was obtained after drying under vacuum at 120° C. overnight.

Step 2: The piperidine-functionalized intermediate polymer was suspended in dimethyl sulfoxide. CH₃I (3 equiv. to piperidone group) and K₂CO₃ (2 equiv. to piperidone group) were added. The solution was stirred at room temperature in a dark environment for 1 d. The resulted viscous solution was precipitated from ethyl acetate, washed with water twice, and completely dried at 80° C. under vacuum. The yield of the piperidinium-functionalized polymer is around 100%.

Step 3: The piperidinium-functionalized polymer was dissolved in dimethyl sulfoxide, filtered through a 0.45 um PTFE filter and casted onto a glass plate. AEMs (in iodide form) were peeled off from the glass plate in contact with deionized water. AEMs in halogenate ion form were obtained by ion exchanging in 1 M salts solution at 80° C. AEMs in hydroxide form was obtained by ion exchanging in 1 M KOH solution at 80° C. The AEMs is noted as PF6TP90, where 6 refers to the number of fluorine in monomer and 90 refers to the ratio of terphenyl monomer.

### Fluorine Content and Ion Exchange Capacity (IEC) of the Different Fluorinated Polyaromatic Polymers

TABLE 1
Ion Exchange Capacity and fluorine content for
the state of the art AEM PAP-TP-X and the herein
reported fluorinated polyaromatic polymers

| | | Fluorine weight |
|---|---|---|
| Membrane | IEC (mmol/g) | percentage |
| Nafion 117 | 0.97 | 67.6% |
| PAP-TP-X (X = 75-100)¹ | 2.37 | 2.4% |
| PF10TP80 | 2.48 | 9.4% |
| PF10TP85 | 2.56 | 7.3% |
| PF10TP90 | 2.63 | 5% |
| PF10TP95 | 2.71 | 2.6% |
| PF26TP85 | 2.22 | 16.4% |
| PF26TP90 | 2.38 | 11.8% |
| PF26TP95 | 2.57 | 6.4% |
| PF42TP85 | 1.96 | 23.4% |
| PF42TP90 | 2.17 | 17.4% |
| PF42TP95 | 2.45 | 9.8% |
| PF26BP90 | 2.84 | 14% |

Nafion 117 is a known proton exchange membrane with high fluorine content, showing that a high fluorine content can show good performance for proton exchange membranes.

The state-of-the-art fluorinated anion exchange membrane PAP-TP-X has a rather low fluorine content of 2.4% but shows a good ion exchange capacity IEC (2.37 mmol/g) as hydroxide exchange membrane.

The fluorinated anion exchange membranes of the present invention show that the fluorine content can be significantly increased, compared to PAP-TP-X, to above 5% and up to 23% while the ion exchange capacity IEC remains on a high level (1.96 mmol/g) or is even increased up to 2.84 mmol/g (Table 1).

### Measurement of Alkaline and Oxidation Stability

Alkaline stability of model FPAP membrane was tested by immersing into 3M KOH at 80° o. over 2000 h. Oxidation stability of model FPAP membrane was tested by immersing into Fenton reagent (3 wt % H₂O₂ and 4 ppm Fe²⁺) at room temperature. After certain treatment time, samples were taken out, rinsed with degassed deionized water, and ion-exchanged with 1M Nal into I⁻ form. The structural changes were monitored by ¹H NMR spectra.

### Measurement of Mechanical Properties

Mechanical properties of PAP and FPAP-x AEMs were measured by Universal Testing Machine (UTM; AGS-500NJ, Shimadzu, Tokyo, Japan) under ambient conditions with a 1 mm min⁻¹ strain rate.

### Measurement of Conductivity

Ion conductivity of PAP and FPAP-x AEMs in OH⁻ form was tested by Autolab PGSTAT302N equipped with Scribner 740 MTS. Samples were cut into 10 mm×30 mm size and ran with the alternative current (AC) impedance on a four-electrode cell with platinum electrodes from 1 Hz to 0.1 MHz. The assembly and measurement processes were operated under N₂ atmosphere to avoid CO₂ contamination. Impedance measurements were carried at different temperature and 100% RH.

### Measurement of Water Uptake and Swelling Ratio

Water uptake (WU) and swelling ratio (SR) of PAP and FPAP-x AEMs can be calculated by:

$$\begin{matrix}WU ( \% ) = \frac{{W}_{w e t} - {W}_{d r y}}{{W}_{d r y}} \times 100 \% \\ SR ( \% ) = \frac{{L}_{w e t} - {L}_{d r y}}{{L}_{d r y}} \times 100 \%\end{matrix}$$

where W_{dry} and L_{dry} were the weight and length of samples after drying in an oven at 80° C. under vacuum, W_{wet} and L_{wet} were the weight and length of samples after immersing in degassed deionized water for 12 h at different temperatures under N₂.

### CITED PRIOR ART DOCUMENTS

1. Yan, Y., Hu, K., Wang, J., et al., Poly (aryl piperidinium) polymers including those with stable cationic pendant groups for use as anion exchange membranes and ionomers; Patent application WO 2017/172824 A1.
2. Bae, C., Lee W., Polymers and methods for their manufacture; U.S. Pat. No. 11,236,196 B2.
3. Wu, X., Chen, N., Klok, H. K., et al., Angew. Chem. Int. Ed., 2022, 61(7):e202114892.
4. Chen, N., Lu, C., Li, Y., et al., J. Membr. Sci., 2019, 588:117120.

All scientific publications and patent documents cited in the present specification are incorporated by reference herein.

1. A fluorinated polyaromatic polymer comprising
at least one fluorinated unit FU of formula I 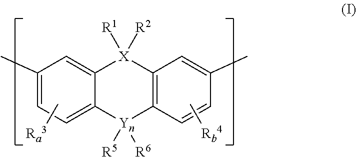
wherein
X is C or N,
Y is C,
R¹, R², R⁵ and R⁶ are independently selected from 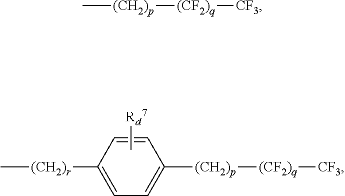
H,
—C₁-C₁₀ alkyl, wherein the —C₁-C₁₀ alkyl is substituted or unsubstituted, particularly —C₁-C₆ alkyl,
—C₂-C₁₀ alkenyl, wherein the —C₂-C₁₀ alkenyl is substituted or unsubstituted, particularly —C₂-C₆ alkenyl,
—C₂-C₁₀ alkynyl, wherein the —C₂-C₁₀ alkynyl is substituted or unsubstituted, particularly C₂-C₆ alkynyl,
wherein at least one of R¹, R², R⁵ and R⁶ is 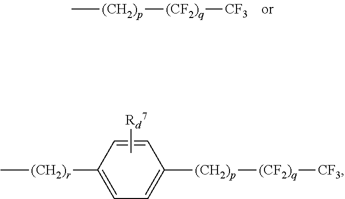
Rₐ³, R_{b}⁴ and R_{d}⁷ are independently selected from
—C₁-C₁₀ alkyl, wherein the —C₁-C₁₀ alkyl is substituted or unsubstituted, particularly —C₁-C₆ alkyl,
—C₂-C₁₀ alkenyl, wherein the —C₂-C₁₀ alkenyl is substituted or unsubstituted, particularly —C₂-C₆ alkenyl,
—C₂-C₁₀ alkynyl, wherein the —C₂-C₁₀ alkynyl is substituted or unsubstituted, particularly C₂-C₆ alkynyl,
a and b are independently 0, 1, 2, or 3, particularly 0 or 1, more particularly 0,
d is 0, 1, 2, 3 or 4, particularly 0 or 1, more particularly 0,
n is 0 or 1,
r is, 1, 2, 3, 4, 5 or 6, particularly, 1, 2, or 3, more particularly 1 or 2,
p is independently between 1 and 20, particularly 1 and 15, more particularly 1 and 9, and
q is independently between 0 and 20, particularly 0 and 15, more particularly 0 and 9,
and
at least one cationic unit CU of formula B or C 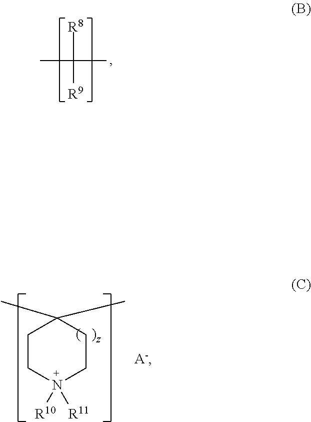
wherein
R⁸ is a partially or fully fluorinated C₁-C₆ alkyl, particularly CF₃,
R⁹ is selected from
—C₁-C₁₀ alkyl, wherein the —C₁-C₁₀ alkyl is substituted or unsubstituted, particularly —C₁-C₆ alkyl,
—C₂-C₁₀ alkenyl, wherein the —C₂-C₁₀ alkenyl is substituted or unsubstituted, particularly —C₂-C₆ alkenyl,
—C₂-C₁₀ alkynyl, wherein the —C₂-C₁₀ alkynyl is substituted or unsubstituted, particularly C₂-C₆ alkynyl,
—(CH₂)ₛ—N(R¹²)₂,
—(CH₂)ₛ—NHR¹²,
—(CH₂)ₛ—N⁺(R¹²)₃,
wherein R¹² is independently selected from
—C₁-C₁₀ alkyl, wherein the —C₁-C₁₀ alkyl is substituted or unsubstituted, particularly —C₁-C₆ alkyl,
—C₂-C₁₀ alkenyl, wherein the —C₂-C₁₀ alkenyl substituted or unsubstituted, particularly —C₂-C₆ alkenyl,
—C₂-C₁₀ alkynyl, wherein the —C₂-C₁₀ alkynyl is substituted or unsubstituted, particularly C₂-C₆ alkynyl,
s is between 0 and 20
-Ph-R_{f}¹³,
R¹⁰ and R¹¹ are independently selected from
H
—C₁-C₁₀ alkyl, wherein the —C₁-C₁₀ alkyl is substituted or unsubstituted, particularly —C₁-C₆ alkyl,
—C₂-C₁₀ alkenyl, wherein the —C₂-C₁₀ alkenyl is substituted or unsubstituted, particularly —C₂-C₆ alkenyl,
—C₂-C₁₀ alkynyl, wherein the —C₂-C₁₀ alkynyl is substituted or unsubstituted, particularly C₂-C₆ alkynyl,
or R¹⁰ and R¹¹ are connected to each other to form a cycloalkyl comprising 4 to 10 C atoms,
z is 0 or 1,
A⁻ is an anion.

2. The fluorinated polyaromatic polymer according to claim 1, comprising at least one bifunctional aromatic moiety BA, wherein the BA is independently selected from a moiety comprising 2 to 5, particularly 2 to 3 cyclic hydrocarbon moieties, wherein the BA is unsubstituted or substituted by one or more substituents independently selected from —C₁-C₁₀-alkyl, —C₁-C₁₀-alkenyl or —C₁-C₁₀-alkynyl, wherein the one or more substituent is unsubstituted or further substituted with one or more halogen atoms or one or more quaternary amines.

3. The fluorinated polyaromatic polymer according to claim 1, comprising at least one linear unit LU comprising
the one or more FU and the one or more CU, and/or
the one or more FU, the one or more CU and the one or more BA, particularly
the one or more FU, the one or more CU and the one or more BA,
wherein the LU is arranged [FU-CU]ₓ-[BA-CU]_{y},
wherein the ratio of x and y is 1:99 to 50:50.

4. The fluorinated polyaromatic polymer according to claim 1, wherein three or more linear units LU form at least one branched unit BU, wherein the three or more linear units LU are connected through at least one branching unit reagent BUR, wherein the at least one BUR is independently selected from a moiety comprising 3 to 6, cyclic hydrocarbon moieties.

5. The fluorinated polyaromatic polymer according to claim 1, wherein two or more linear units LU form at least one crosslinked unit CU, wherein the two or more linear units LU are crosslinked through at least one crosslinker CL, wherein the at least one crosslinker CL is independently selected from an aliphatic or aromatic quaternary diamine.

6. The fluorinated polyaromatic polymer according to claim 1, wherein the at least one fluorinated unit FU is independently selected from 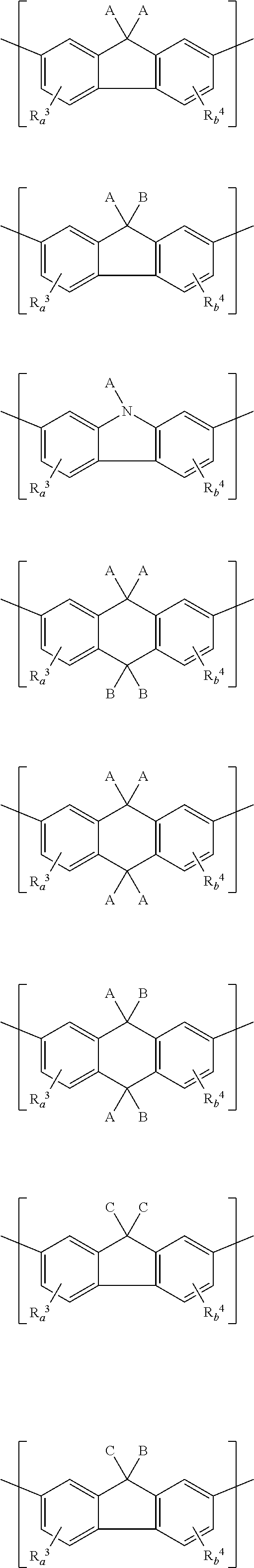
wherein
A is independently selected from —(CH₂)ₚ—(CF₂)_{q}—CF₃,
B, R³ and R⁴ are independently selected from—
—C₁-C₁₀ alkyl, wherein the —C₁-C₁₀ alkyl is substituted or unsubstituted, particularly —C₁-C₆ alkyl,
—C₂-C₁₀ alkenyl, wherein the —C₂-C₁₀ alkenyl is substituted or unsubstituted, particularly —C₂-C₆ alkenyl,
—C₂-C₁₀ alkynyl, wherein the —C₂-C₁₀ alkynyl is substituted or unsubstituted, particularly C₂-C₆ alkynyl, R_{d}⁷
C is independently selected from 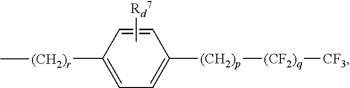
wherein R_{d}⁷ is independently selected from
—C₁-C₁₀ alkyl, wherein the —C₁-C₁₀ alkyl is substituted or unsubstituted, particularly —C₁-C₆ alkyl,
—C₂-C₁₀ alkenyl, wherein the —C₂-C₁₀ alkenyl is substituted or unsubstituted, particularly —C₂-C₆ alkenyl,
—C₂-C₁₀ alkynyl, wherein the —C₂-C₁₀ alkynyl is substituted or unsubstituted, particularly C₂-C₆ alkynyl,
d is 0, 1, 2, 3 or 4,
r is, 1, 2, 3, 4, 5 or 6, particularly 1, 2 or 3, more particularly 1 or 2,
p is independently between 1 and 20, particularly 1 and 15, more particularly 1 and 9, and
q is independently between 0 and 20, particularly 0 and 15, more particularly 0 and 9,
a and b are independently 0, 1, 2, or 3.

7. The fluorinated polyaromatic polymer according to claim 1, wherein the at least one bifunctional aromatic moiety BA is independently selected from 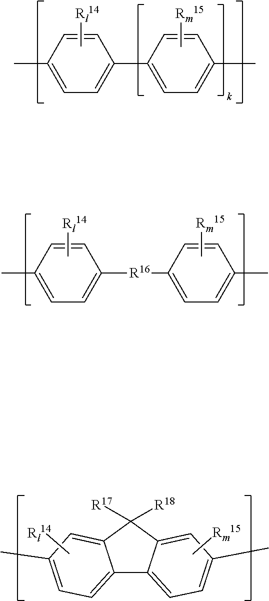
wherein
R¹⁴, R¹⁵, R¹⁶, R¹⁷ and R¹⁸ are independently selected from
—C₁-C₁₀ alkyl, wherein the —C₁-C₁₀ alkyl is substituted or unsubstituted, particularly —C₁-C₆ alkyl,
—C₂-C₁₀ alkenyl, wherein the —C₂-C₁₀ alkenyl is substituted or unsubstituted, particularly —C₂-C₆ alkenyl,
—C₂-C₁₀ alkynyl, wherein the —C₂-C₁₀ alkynyl is substituted or unsubstituted, particularly C₂-C₆ alkynyl,
l and m are independently 0, 1, 2, 3 or 4,
k is 0 to 4, particularly 1 to 4, more particularly 1 or 2.

8. The fluorinated polyaromatic polymer according to claim 1, wherein the at least one branching unit BU is independently selected from

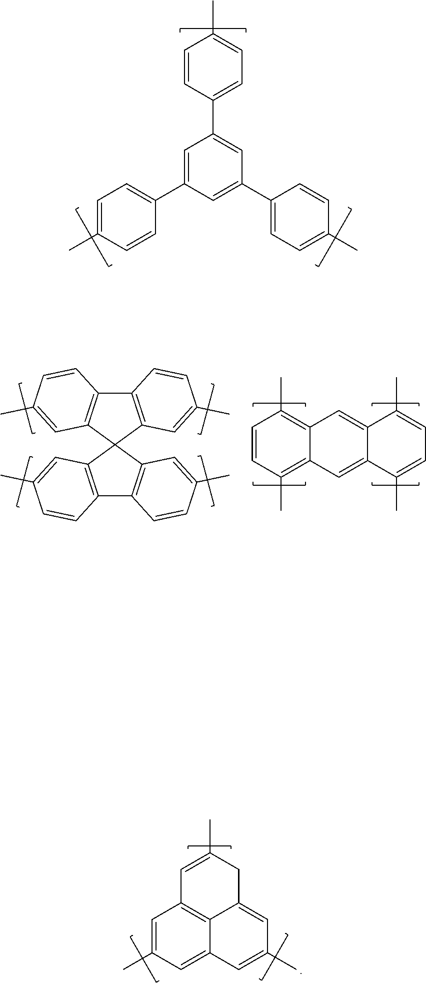

9. The fluorinated polyaromatic polymer according to claim 1, wherein the at least one crosslinking unit CLU is independently selected from 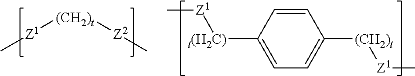
wherein
Z¹ is R¹⁹R²⁰ or NR²¹R²²,
Z² is R¹⁹R²⁰ or N⁺R²¹R²²R²³,
R¹⁹ and R²⁰ are independently selected from
the group of halogens
—C₁-C₁₀ alkyl, wherein the —C₁-C₁₀ alkyl is substituted or unsubstituted, particularly —C₁-C₆ alkyl,
—C₂-C₁₀ alkenyl, wherein the —C₂-C₁₀ alkenyl is substituted or unsubstituted, particularly —C₂-C₆ alkenyl,
—C₂-C₁₀ alkynyl, wherein the —C₂-C₁₀ alkynyl is substituted or unsubstituted, particularly C₂-C₆ alkynyl,
R²¹, R²² and R²³ are independently selected from
H
—C₁-C₁₀ alkyl, wherein the —C₁-C₁₀ alkyl is substituted or unsubstituted, particularly —C₁-C₆ alkyl,
—C₂-C₁₀ alkenyl, wherein the —C₂-C₁₀ alkenyl is substituted or unsubstituted, particularly —C₂-C₆ alkenyl,
—C₂-C₁₀ alkynyl, wherein the —C₂-C₁₀ alkynyl is substituted or unsubstituted, particularly C₂-C₆ alkynyl,
t is between 0 and 20, particularly 0 to 12, more particularly 0 to 6.

10. The fluorinated polyaromatic polymer according to claim 1, wherein the fluorine content is 2.5% to 80%, particularly 5% to 60%, more particularly 5 to 30%.

11. A method for preparing a fluorinated polyaromatic polymer comprising one or more linear units LU comprising reacting at least one fluorinated unit precursor FUP and optionally at least one cationic unit precursor CUP and optionally at least one bifunctional aromatic moiety precursor BAP.

12. The method for preparing a fluorinated polyaromatic polymer of claim 11, wherein the fluorinated polyaromatic polymer comprises a branched unit BU comprising three or more linear units LU connected through a branching unit reagent BUR, the method comprising comprising reacting at least one fluorinated unit precursor FUP and optionally at least one cationic unit precursor CUP and optionally at least one bifunctional aromatic moiety precursor BAP and a branching unit precursor BUP.

13. A method for preparing a fluorinated polyaromatic polymer comprising a crosslinking unit CU comprising two or more linear units LU connected through one or more crosslinkers CL comprising
reacting at least one fluorinated unit precursor FUP and at least one cationic unit precursor CUP and optionally at least one bifunctional aromatic moiety precursor BAP yielding an intermediate polymer, and
reacting the intermediate polymer with at least one crosslinking unit precursor CLU.
